(19) United States
(12) Patent Application Publication
(10) Pub. No.: US 2025/0191853 A1
(43) Pub. Date: Jun. 12, 2025

(54) METAL-DOPED ACTIVATED CARBON

(71) Applicant: CARBONIP TECHNOLOGIES INC., Port Coquitlam (CA)

(72) Inventors: Jin Kwon TAK, Vegreville (CA); Earl JENSON, Vegreville (CA); Matthew SIEBERT, Vancouver (CA)

(21) Appl. No.: 18/841,381

(22) PCT Filed: Aug. 15, 2023
(86) PCT No.: PCT/CA2023/051081

§ 371 Date: Aug. 25, 2024

Related U.S. Application Data
(60) Provisional application No. 63/398,816, filed on Aug. 17, 2022.

(51) Int. Cl. H01G 11/34; C01B 32/318; C01B 32/354; H01M 4/62; H01M 10/052

(52) U.S. Cl. CPC H01G 11/34; C01B 32/318; C01B 32/354; H01M 4/625; H01M 10/052; C01P 2004/61; C01P 2006/11; C01P 2006/12; C01P 2006/14

(57) ABSTRACT

A composition incorporating activated carbon, an electro-stabilizing agent and/or a wettability enhancing agent. Methods of producing conductive activated carbon including a step of combining activated carbon with an electro-stabilizing agent and/or a wettability enhancing agent to form an activated carbon mixture; and exposing the activated carbon mixture to a sweeping gas at an elevated temperature. The electro-stabilizing agent can be copper. The wettability enhancing agent can be aluminum.

### CROSS-REFERENCE TO RELATED APPLICATIONS

This application claims priority to, and the benefit of, U.S. provisional patent application No. 63/398,816 filed 17 Aug. 2022 entitled Metal-Doped Activated Carbon, the entirety of which is incorporated by reference herein in its entirety for all purposes.

### TECHNICAL FIELD

Some embodiments relate to methods for making activated carbon having a relatively high conductance. Some embodiments relate to methods for making activated carbon having a relatively low oxygen content. Some embodiments relate to methods for making activated carbon having metal doped therein and a relatively high ionic conductance. Some embodiments relate to activated carbon or activated carbon having metal doped therein and having a relatively low internal resistance made by the methods described herein. Some embodiments relate to supercapacitors or batteries having electrodes made from such materials.

### BACKGROUND

Electrochemical energy storage devices use physical and chemical properties as charges. For example, supercapacitors use a physical storage mechanism to generate high power with a long lifetime. Batteries employ redox reactions to store and release energy.

The electrodes of energy storage systems require high adsorptive capacity with good microporocities and low electrical resistances in supercapacitor and battery applications, including lithium-sulphur (LiS) battery applications. Typical activated carbons have high adsorptive capabilities, but generally not suitable electrical properties. The typical activated carbon has oxygen-related functional groups which are chemically bound on the surface, which can contribute to a shortening of the lifespan of the supercapacitors and lithium-sulphur batteries.

Subject to addressing the shortcomings of their electrical properties, carbon materials such as activated carbon can provide a useful material for the manufacture of electrodes. For example, carbon-based materials can be designed as highly porous materials so as to have a high surface area. The pore sizes in the material can be micro-porous primarily to provide a high surface area. Carbon materials can also offer good adsorption (i.e. adhesion of ions onto the surface of the material) and low resistance (i.e. efficient electron and ion movement at high current). Carbon pore sizes can be described as micropores (having a pore width of less than 2 nm), mesopores (having a pore width of between 2 nm and 50 nm) and macropores (having a pore width of greater than 50 nm).

Activated carbon has been used for electrode materials due to high surface area (1,000-3,000 m²/g). Activated carbons are widely produced from many natural substances such as coal (lignite, bituminous, and anthracite coal), peat, wood, and coconut shell. Among these natural raw materials, coconut shell makes a good activated carbon because of predominant microporocity which is less than 2 nm that the supercapacitor carbon requires.

The production of activated carbons mainly involves carbonization and activation with an oxidizing or activation agent. The carbonization converts the natural substances into char (carbon) under a reducing-atmosphere. The char is partially oxidized to produce activated carbon. The activation develops the porous surface of activated carbons, but this partial oxidation process can not remove oxygen-containing functional groups. Oxygen-containing functional groups can create parasitic reactions for supercapacitors that diminish the initial capacitance and limit the lifespan when activated carbons are used for electrode materials of supercapacitors. The oxygen-containing functional groups also create high electrical resistances for supercapacitors and for battery applications such as lithium-sulphur applications.

Examples of potential applications for activated carbon materials with improved electrical properties include supercapacitors and batteries, including metal sulphur, e.g. lithium-sulphur (LiS), batteries. Supercapacitors, known as electrochemical double layer capacitors (EDLCs), are high capacity capacitors that can bridge the gap between electrolytic capacitors and rechargeable batteries. Supercapacitors can potentially store more power per unit volume or mass than electrolytic capacitors (e.g. typically 10 to 100 times more power), and can accept and deliver charge much faster than batteries because charging/discharging involves only physical movement of ions, not a chemical reaction. Supercapacitors can also tolerate many more charge and discharge cycles than can a battery, and are useful for bursts of power, for example to recover and supply electrical power in a hybrid vehicle during regenerative braking or for energy storage as part of a building or building component. Carbon is a desirable material for supercapacitors because it has high surface area and favourable cost.

A growing area of interest in rechargeable battery technology is lithium-sulphur (Li—S) batteries. A lithium-sulphur battery has a lithium-metal anode and a sulphur cathode. Sulphur and lithium have theoretical capacities of 1672 or 1675 mA h g⁻¹, respectively. As such, a theoretical energy density of a LiS battery is 2500 Wh kg⁻¹, which is one of the highest theoretical energy densities among rechargeable batteries. As such, lithium-sulphur batteries provide a promising electrical energy-storage system for portable electronics and electric vehicles.

Lithium-sulphur (LiS) batteries operate by reduction of sulphur at the cathode to lithium sulphide:

$$S + 16 Li ↔ 8 {Li}_{2} S ( 2.4 V - 1.7 V )$$

The sulphur reduction reaction to lithium sulphide is complex and involves the formation of various lithium polysulphides (Li₂Sₓ, 8<x<1, e.g. Li₂S₈, Li₂S₆, Li₂S₄, and Li₂S₂).

In the case of some lithium-sulphur batteries, the anode can be pure lithium metal (Li° oxidized to Li⁺ during discharge), and in some cases the cathode can be activated carbon containing sulphur (S° that is reduced to S²⁻ (sulphides) during discharging). An ion-permeable separator is provided between the anode and the cathode, and an electrolyte used in such systems is generally based on a mixture of organic solvents such as cyclic ethers such as 1,2-dimethoxyethane (DME) and 1,3-dioxolane (DOXL) containing 1 molar lithium bis(trifluoromethane sulfonyl)imide (LiN(SO₂CF₃)₂) and 1% lithium nitrate, or the like.

Potential advantages of lithium-sulphur batteries include a high energy density (theoretically 5 times although practically 2-3 times more than lithium-ion), there is no requirement for top-up charging when in storage (whereas a lithium-ion battery may require 40% regular recharging to prevent capacity loss), the active materials are lighter as compared to lithium-ion, and the materials used in the manufacture of lithium-sulphur batteries are more environmentally friendly and less expensive than lithium-ion batteries (since no rare earth metals are required).

However, there are challenges for lithium-sulphur battery systems that have not yet been addressed sufficiently to make them commercially useful. For example, lithium polysulphides (Li₂Sₓ where x is an integer between 3 and 8) dissolve in the electrolyte and further reduce to insoluble lithium sulphide (e.g. Li₂S₂ to Li₂S) that forms on the anode in the battery systems. Such formations create a loss of active material, resulting in a short life cycle (i.e. fewer discharging and charge cycles) that is not commercially useful.

Also, because sulphur is electronically and ionically insulating, sulphur needs to be embedded into a conductive matrix to be used in a lithium sulphur battery. Carbon is a potentially useful material for lithium-sulphur battery electrodes because it has a porous structure that supports the deposition of lithium polysulphide, and can help to minimize electrode expansion during discharge. The cathode of a lithium-sulphur battery can be made from sulphur-impregnated activated carbon as an active material that reacts with lithium ions from the lithium metal at the anode side. The electrodes require high adsorptive capacity with microporocities and low electrical resistances for creating high capacitance for supercapacitors and storing and mitigating the formation of insoluble polysulphides at the anode side which causes shortened lifetime for LiS batteries.

Many forms of activated carbon also include a high percentage of oxygen, e.g. in the range of about 15%, generally in the form of oxygen-containing functional groups. Oxygen is an insulating material, and its presence in activated carbon increases the resistance of the carbon product.

The adoption of a green economy and renewable energy sources such as wind and solar power necessitate the adoption of better energy storage systems. The production of power from a renewable energy source cannot be predictably controlled, and in order for such sources to supply a significant proportion of power to a power grid, reliable and significant energy storage systems are required to balance the irregular power generation provided by the renewable energy source. The provision of meaningful energy storage systems allows power to be stored during periods of power production, and allows power to be supplied to the grid during periods of decreased power production from the renewable energy source. However, such energy storage systems must be quite large to be able to achieve the desired stabilization of the electrical grid.

One strategy to provide energy storage systems that can facilitate the widespread production of power from renewable energy sources is to incorporate such energy storage systems into buildings or building components. This strategy can allow for the storage of large amounts of energy without generating a significant separate footprint for the energy storage system. However, energy storage systems that are to be used as part of a building or building component need to be robust and reliable (e.g. have a long life encompassing many charge and discharge cycles), because replacement or repair of such systems may be difficult or disruptive to other uses of the building. Further, such energy storage systems should provide a high energy density, in order to maximize energy storage while minimizing the amount of space occupied by such energy storage systems.

There remains a need for technologies that improve the capabilities of supercapacitors and/or metal-sulphur including lithium-sulphur battery systems. The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In some aspects, a composition containing activated carbon, an electro-stabilizing agent and/or a wettability enhancing agent is provided. In some aspects, a method of producing conductive activated carbon is provided and involves combining activated carbon with an electro-stabilizing agent and/or a wettability enhancing agent to form an activated carbon mixture and exposing the activated carbon mixture to a sweeping gas at an elevated temperature.

In some aspects, the electro-stabilizing agent is a conductive metal. In some aspects, the electro-stabilizing agent is a transition metal. In some aspects, the electro-stabilizing agent is Sc, Ti, V, Cr, Mn, Fe, Co, Ni, Cu, Zn, Y, Zr, Nb, Mo, Tc, Ru, Rh, Pb, Ag, La, Hf, Ta, W, Re, Os, Ir, Pt, Au, or Ac. In some aspects, the electro-stabilizing agent is Ni or Cu. In some aspects, the electro-stabilizing agent is copper. In some aspects, the wettability enhancing agent is aluminum. In some aspects, the wettability enhancing agent is alumina or activated alumina.

In some aspects, the electro-stabilizing agent is a metal and the metal is present in an amount of about 0.5% to about 4.0% by weight based on the elemental content of the metal. In some aspects, the wettability enhancing agent is a metal and is present in an amount of about 0.15% to about 1.5% by weight based on the elemental content of the metal.

In some aspects, an electrode containing an activated carbon composition or an activated carbon made by a method as described herein is provided. In some aspects, a supercapacitor or a battery comprising such an electrode is provided.

In one aspect, a lithium sulphur battery containing such an electrode is provided, wherein the electrode includes activated carbon containing the electrical stabilizing agent at a concentration in the range of about 0.5% to about 3.5% by weight, and/or wherein the electrode includes activated carbon containing the wettability enhancing agent at a concentration in the range of about 0.1% to about 0.2% by weight.

In one aspect, a supercapacitor containing such an electrode is provided, wherein the electrode includes activated carbon containing the electrical stabilizing agent at a concentration in the range of about 1% to about 3.5% by weight, and/or wherein the electrode includes activated carbon containing the wettability enhancing agent at a concentration in the range of about 0.45% to about 1.0% by weight.

In some aspects, a building or modular building component containing an energy storage system containing a supercapacitor or battery as described herein is provided.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example embodiment of a process for preparing doped activated carbon according to one embodiment.

FIG. 2 shows an example embodiment of a process for the fabrication of electrodes used in supercapacitors.

FIG. 3 shows an example embodiment of process for preparing an activated carbon cathode for a lithium-sulphur battery.

FIG. 4 shows an example embodiment of a process for assembling a cathode with a lithium metal anode for a lithium-sulphur battery.

FIG. 5 shows the 500 cycle performance of LiS batteries with a first baseline LAAC.

FIG. 6 shows the 500 cycle performance of LiS batteries with a second baseline LAAC.

FIG. 7 shows the first 50 cycles of the 500 cycle performance of LiS batteries with the first baseline LAAC.

FIG. 8 shows the first 50 cycles of the 500 cycle performance of LiS batteries with the second baseline LAAC.

FIG. 9 shows the 500 cycle performance of LiS batteries with a first metal-doped LAAC.

FIG. 10 shows the 500 cycle performance of LiS batteries with a second metal-doped LAAC.

FIG. 11 shows the first 50 cycles of the 500 cycle performance of LiS batteries with the first metal-doped LAAC.

FIG. 12 shows the first 50 cycles of the 500 cycle performance of LiS batteries with the second metal-doped LAAC.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In one example embodiment, the inventors have developed a novel process for producing carbon having desirable physical properties. Such carbon has potential utility, for example, to manufacture electrodes for use in energy storage, for example in supercapacitors, metal-sulphur batteries, lithium-sulphur batteries, and so on. The inventors have determined that doping activated carbon with metals that can serve as a wettability enhancing agent and an electro-stabilizing agent can improve the conductivity and/or physical properties of the activated carbon, particularly after the activated carbon has been treated to reduce the number of functional groups present.

In particular tested example embodiments, lignin A (LA), lignin B (LB), and black liquor (BL, which contains dissolved lignin in alkaline solution) were used to produce lignin-based activated carbons, using potassium hydroxide (KOH) as an exemplary oxidizing agent. Lignin-based activated carbons were treated with a sweeping gas (SG) treatment using a reducing gas for the removal of oxygen-containing functional groups. YP50F (YPAC, derived from coconut shell) was selected as a comparative type of biologically based renewable source activated carbon.

The metal-doped activated carbons tested in the examples were observed to show significantly improved adsorptive capability and electrical properties resulting in high capacitance values in the tested supercapacitor applications. The metal-doped activated carbons are suitable for electrode materials in supercapacitors and battery applications such as metal-sulphur including lithium-sulphur batteries.

As used herein a renewable source of activated carbon refers to a source of carbon that can replenish itself naturally (e.g. that is derived from a biologically based source such as lignin or coconut), as opposed to a non-renewable source of activated carbon such as coal or oil by-products.

As used herein, lignin refers to both lignin A, lignin B, and black liquor. Lignin A and B are kraft lignin with a low ash (<2% by mass) and high ash (<25% by mass), respectively. Pulp and paper biosolids (also called “activated sludge”) that remain after biogas digestion is another feedstock that contains a high level of lignin. In preparing biogas, the biodegradable biosolids convert to biogas through digestion and then non-degradable parts are left. The major component of the non-degradable parts is lignin. A high-lignin feedstock refers to a material that contains a significant proportion of lignin (e.g. between 65% and 98% or higher lignin dry matter content, including any subrange therebetween e.g. at least 65%, 70%, 75%, 80%, 85%, 90%, 95%, 96%, 97%, 98% or greater than 98% lignin dry matter content by weight), or from black liquor obtained from a pulping process (which typically contains between 10-15% lignin in its wet matter content, including any value therebetween including 11, 12, 13 or 14% lignin by weight, and which may contain at least 20-35% or higher recoverable lignin by weight in its dry matter content including any subrange therebetween e.g. at least 20%, 21%, 22%, 23%, 24%, 25%, 26%, 27%, 28%, 29%, 30%, 31%, 32%, 33%, 34% or 35% recoverable lignin by weight on a dry matter basis). In some embodiments, the high-lignin feedstock has a recoverable lignin content of between 65% and 98% or higher by weight on a dry basis, including any subrange therebetween e.g. at least 65%, 70%, 75%, 80%, 85%, 90%, 95%, 96%, 97%, 98% or greater than 98% recoverable lignin by weight on a dry basis).

In one example embodiment, activated carbon is ground and mixed with a dissolved salt of an electro-stabilizing agent and/or a dissolved salt of a wettability enhancing agent. The resulting preparation is dried, leaving the metal salts physically embedded in the activated carbon. The dried carbon is subjected to a sweeping gas treatment to remove oxygen from the material and convert the metal salt to its oxide form and/or elemental form, leaving the metal doped in the carbon. The electro-stabilizing agent may help to improve capacitance values by providing high capacitance at a fast discharge. The wettability enhancing agent may improve the interactions of the activated carbon with solvents and electrolytes.

More specifically and without being bound by theory, typical activated carbon contains a high number of oxygen-containing functional groups which have favourable interactions with polar solvents. The oxygen is chemically bound to the activated carbon and results in high electrical resistance when used as an electrode material. A sweeping gas treatment conducted as described herein using an anoxic gas or under reducing conditions can be used to reduce (and thereby remove) oxygen-based functional groups from the activated carbon, resulting in an increase in the carbon content of the activated carbon. The oxygen-stripped activated carbon becomes highly non-interactive with polar solvents, including the polar solvents that are used as electrolytes in supercapacitors and lithium sulphur batteries.

Most high-performance supercapacitors contain an organic electrolyte. For example, the electrolyte can contain a conductive salt (e.g. tetraethylammonium tetrafluoroborate or TEABF₄) which is dissolved in an acetonitrile solvent (a polar solvent). The activated carbon produced through the sweeping gas process described herein (i.e. a highly pure carbon with a minimum amount of oxygen-based functional groups) is highly non-interactive with polar solvents. The wettability (interaction) is poor between the electrolyte and the non-polar surface of the activated carbon. The poor wettability creates less ion-mobility of TEABF₄ in activated carbon-based electrodes resulting in a poor internal resistance (or ionic impedance or diffusion resistance which is different from electrical resistance) of the activated carbon-based supercapacitors. Without being bound by theory, addition of a wettability enhancing agent, such as doping the activated carbon with aluminum or other suitable wettability enhancing agent, can improve the ion mobility of the electrolyte (e.g. by improving ionic interactions between the electrode and the electrolyte).

Without being bound by theory, it is believed that activated carbon that is doped with a metal oxide, a metal or a metal complex as described herein will provide a high capacitance with low internal resistance for supercapacitors, and will minimize the migration of lithium polysulphides and subsequent deposition of insoluble lithium sulfide into the anode of the lithium sulphur battery. Additionally, it was observed that metal doping reduces the amount of a solvent required when the activated carbon slurry is coated on an aluminum foil for forming the electrode of a supercapacitor, and improves the coating properties of the activated carbon slurry is on an aluminium foil.

In some embodiments, the electrical stabilizing agent and/or the wettability enhancing agent are non-combustible.

The preparation of activated carbon using lignin or a high-lignin feedstock is described, for example, in PCT application No. PCT/CA2022/050218 filed 15 Feb. 2022, the entirety of which is incorporated by reference herein in its entirety.

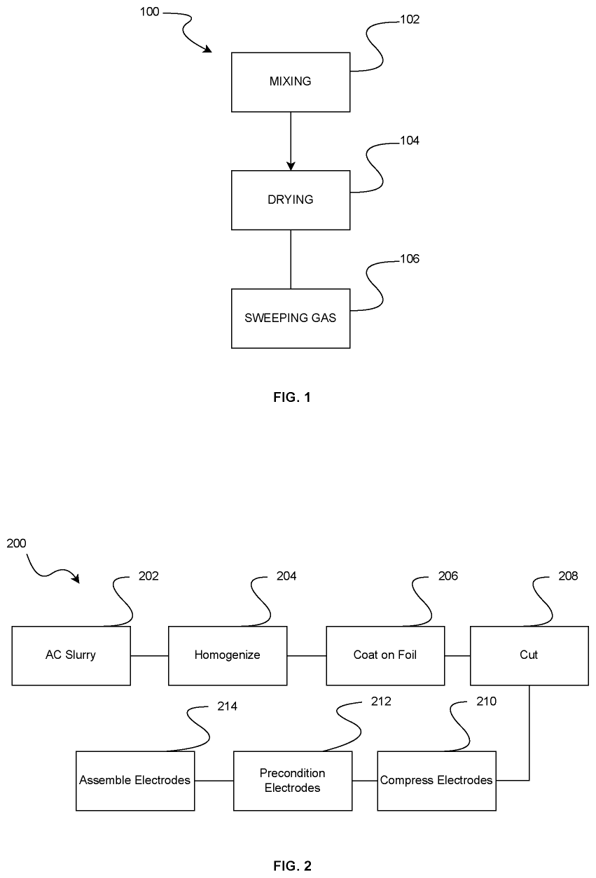

With reference to FIG. 1, an example embodiment of a process 100 for preparing metal-doped activated carbon is illustrated. At 102, mixing is carried out to combine one or more electro-stabilizing agents and/or wettability enhancing agents with activated carbon as described further below. In some embodiments, the electro-stabilizing and/or wettability enhancing agent are provided as a solution, and the solution is mixed with the activated carbon and agitated for a period of time, e.g. % hour to 1 hour. In some aspects, mixing can be carried out to combine the substances using a ball mill or other suitable apparatus. In some aspects, micro-grinding can be carried out at 102. In some aspects, the combined substances are further milled after mixing using a planetary ball mill or other suitable apparatus for a period of time, e.g. % hour to 1 hour. The mixed and/or ground/micro-ground substances can be further processed at 102 if desired. At 104, the mixture is dried. At 106, the mixture is subjected to a sweeping gas treatment, for example as described in PCT/CA2022/050218.

In one example embodiment, after drying at 104, at 106 the activated carbon is subjected to a sweeping gas process at elevated temperature. In some embodiments, the sweeping gas process is carried out using a reducing gas in combination with an inert gas. Examples of gas that may be used as a reducing gas include hydrogen, ammonia, carbon monoxide, forming gas, syngas, or the like. Forming gas is a mixture of hydrogen and nitrogen known in the art. Syngas is a mixture of carbon monoxide and hydrogen known in the art. Examples of inert gas include nitrogen, helium and argon.

In some embodiments, the gas used to carry out the sweeping gas process contains between about 80% to about 98% inert gas, including any value or subrange therebetween e.g. 82, 84, 86, 88, 90, 91, 92, 93, 94, 95, 96 or 97% inert gas, and between about 2% to about 20% reducing gas, including any value or subrange therebetween e.g. 3, 4, 5, 6, 7, 8, 9, 10, 11, 12, 13, 14, 15, 16, 17 or 18%. In some embodiments, the gas used to carry out the sweeping gas process contains between 90-96% inert gas and 4-10% reducing gas. In some embodiments, the sweeping gas contains 96% argon and 4% hydrogen.

In some embodiments, the activated carbon mixture is provided to the sweeping gas treatment as a thin layer of solids, for example spread on a tray. In some embodiments, the activated carbon mixture is held stationary during the sweeping gas treatment.

In some embodiments, the sweeping gas is applied at a flow rate of approximately 0.25 to 1 L/minute in a 6″ tube furnace at atmospheric pressure, including any value therebetween e.g. 0.30, 0.35, 0.40, 0.45, 0.50, 0.55, 0.60, 0.65, 0.70, 0.75, 0.80, 0.85, 0.90 or 0.95 L/minute. The flow rate at which the sweeping gas is applied can be adjusted by one skilled in the art depending on the type of apparatus used to carry out the process. Step 106 can be carried out in any suitable apparatus, e.g. a tube furnace, rotary kiln, fluidized bed reactor or other suitable apparatus can be used in various embodiments.

In some embodiments, the sweeping gas is sprayed over or through the activated carbon material at step 106. In some embodiments, a sufficient amount of the sweeping gas is supplied to the activated carbon material so that there is a molar excess of hydrogen gas relative to the number of oxygen functional groups in the activated carbon. In some embodiments the sweeping gas has a superficial velocity relative to the surface of the activated carbon material of between about 0.25 cm/min and 7.0 cm/min, including any value therebetween e.g. 0.50, 0.75, 1.0, 1.25, 1.50, 1.75, 2.0, 2.25, 2.50, 2.75, 3.0, 3.25, 3.50, 3.75, 4.0, 4.25, 4.50, 4.75, 5.0, 5.25, 5.50, 5.75, 6.0, 6.25, 6.50 or 6.75 cm/min.

In some embodiments, the sweeping gas process at 106 is conducted at an elevated temperature, and the elevated temperature is a temperature in the range of between about 750° C. and about 950° C., including any value or subrange therebetween, e.g. 775, 800, 825, 850, 875, 900, 925 or 950° C. In some embodiments, the sweeping gas treatment is conducted for a period between about 0.5 hours and about 9 hours, including any value or subrange therebetween, e.g. 0.6, 0.7, 0.8, 0.9, 1.0, 1.1, 1.2, 1.3, 1.4, 1.5, 1.6, 1.7, 1.8, 1.9, 2.0, 2.5, 3.0, 3.5, 4.0, 4.5, 5.0, 5.5, 6.0, 6.5, 7.0, 7.5, 8.0, or 8.5 hours.

In some embodiments, at 102, a suitable source of activated carbon is combined with an electro-stabilizing agent and/or a wettability enhancing agent. The activated carbon can be ground to a relatively small particle size. In some embodiments, the activated carbon is ground to a size in the range of about 1 μm to about 10 μm, including any value or subrange therebetween, e.g. 2, 3, 4, 5, 6, 7, 8 or 9 μm. In one embodiment, the activated carbon is ground to a size in the range of about 1 μm to about 10 μm, with a mean size of 6 μm.

Any suitable form of activated carbon can be used in various embodiments. Suitable sources of activated carbon include carbonized biomass, including coconut, nutshells, lignin or a high-lignin feedstock, coal, peat, wood and the like, which can be converted to activated carbon in any desired manner.

In some embodiments, the electro-stabilizing agent is a conductive metal. In some embodiments, the electro-stabilizing agent is a transition metal. In some embodiments, the electro-stabilizing agent is Sc, Ti, V, Cr, Mn, Fe, Co, Ni, Cu, Zn, Y, Zr, Nb, Mo, Tc, Ru, Rh, Pb, Ag, La, Hf, Ta, W, Re, Os, Ir, Pt, Au, or Ac. In some embodiments, the electro-stabilizing agent is Cu. In some embodiments, the electro-stabilizing agent is Ti, V, Ni, Cr, Co, Cu, Fe, Zn, Mn or Mo. In some embodiments, the electro-stabilizing agent is a conductive metal. In some embodiments, the electro-stabilizing agent is a metal that has non-faradaic reactions in supercapacitors. In some embodiments, the electro-stabilizing agent is copper (Cu) or nickel (Ni) which are commonly used as current collectors for supercapacitors. In some embodiments, the electro-stabilizing agent is Cu. In some embodiments in which the electro-stabilizing agent is Fe, a level of Fe in an electrode fabricated using the activated carbon is less than 50 ppm.

In some embodiments, the wettability enhancing agent is aluminum. In some embodiments, the wettability enhancing agent is an aluminum oxide, e.g. AlO (aluminum (II) oxide) or Al₂O₃ (aluminum (Ill) oxide, i.e. alumina), activated alumina (γ-Al₂O₃), or any other compound that can provide better interactions between polar and non-polar substances.

In some embodiments, the electro-stabilizing agent and/or the wettability enhancing agent are supplied at 102 as a solution of a metal salt, e.g. a salt of the metal with chloride, hydroxide, nitrate, sulphate, or the like, e.g. copper nitrate, copper sulphate, aluminum nitrate, aluminum sulphate, or the like. In some embodiments, the metal salt is provided in an aqueous solution, or in solution with any acceptable solvent (e.g. water, methanol, ethanol, and/or any other polar solvents) at 102. In one example embodiment, the electro-stabilizing agent is copper and the copper is supplied as copper sulphate (e.g. CuSO₄·5H₂O). In one example embodiment, the wettability enhancing agent is aluminum and the aluminum is supplied as aluminum nitrate (e.g. Al(NO₃)₃·9H₂O).

In some embodiments, the amount of the electro-stabilizing agent that is combined with the activated carbon is in the range of about 0.5% to about 4.0% elemental content by weight in the finished product, including any value or subrange therebetween e.g. 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8 or 3.9%. In some embodiments, the amount of the electro-stabilizing agent that is combined with the activated carbon is in the range of about 1% to about 3.5% elemental content by weight based on the elemental content of the metal, including any value or subrange therebetween, e.g. 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4 or 3.5%. In some embodiments, the amount of the electro-stabilizing agent that is combined with the activated carbon is less than about 4.0% by weight based in the elemental content of the metal, including e.g. less than about 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6 or 0.5% by weight.

In some embodiments, the amount of the wettability enhancing agent supplied at 102 is in the range of about 0.15% to about 1.50% by weight based on the elemental content of the metal by weight in the finished product, including any value or subrange therebetween, e.g. 0.20, 0.25, 0.30, 0.35, 0.40, 0.45, 0.50, 0.55, 0.60, 0.65, 0.70, 0.75, 0.80, 0.85, 0.90, 0.95, 1.0, 1.05, 1.10, 1.15, 1.20, 1.25, 1.30, 1.35, 1.40 or 1.45%. In some embodiments, the amount of the wettability enhancing agent supplied at 102 is in the range of about 0.45% to about 1.00% by weight based on the elemental content of the metal, including any value or subrange therebetween, e.g. 0.45, 0.50, 0.55, 0.60, 0.65, 0.70, 0.75, 0.80, 0.85, 0.90, 0.95, or 1.0%.

In some embodiments in which the activated carbon is produced from lignin, the electro-stabilizing agent is present in an amount of between about 2.75% and 3.25% by weight, including any value therebetween e.g. 2.80, 2.85, 2.90, 2.95, 3.0, 3.05, 3.10, 3.15 or 3.20% by weight, and the wettability enhancing agent is present in an amount of between about 0.50% and 1.25% by weight, including any value therebetween, e.g. 0.55, 0.60, 0.65, 0.70, 0.75, 0.80, 0.85, 0.90, 0.95, 1.0, 1.05, 1.10, 1.15 or 1.20% by weight.

In some embodiments in which the activated carbon is produced from coconut husk, the electro-stabilizing agent is present in an amount of between about 2.75% and 3.25% by weight, including any value therebetween e.g. 2.80, 2.85, 2.90, 2.95, 3.0, 3.05, 3.10, 3.15 or 3.20% by weight, and the wettability enhancing agent is present in an amount of between about 0.25% and 1.00% by weight, including any value therebetween, e.g. 0.30, 0.35, 0.40, 0.45, 0.50, 0.55, 0.60, 0.65, 0.70, 0.75, 0.80, 0.85, 0.90, or 0.95% by weight.

In some embodiments, any other desired additives or components can be added at 102 in a similar manner as described for the electro-stabilizing agent and the wettability enhancing agent. For example, in some embodiments conductivity enhancing additives such as graphene, graphite or the like are added at 102 or after completion of sweeping gas treatment at 106.

In some embodiments, after the activated carbon has been combined with the metal salt, at 104 the resulting mixture is dried. Any suitable drying conditions can be used to carry out step 104, including ambient conditions. In some embodiments by way of example only, drying is carried out at a temperature in the range of about 70° C., e.g. between about 60° C. and 80° C. in a convection oven for a period of approximately 48 hours. In some embodiments, drying is carried out under atmospheric pressure. In some embodiments, drying is carried out under vacuum, e.g. at a pressure in the range of about 10 to about 760 mmHg, including any value therebetween e.g. 20, 50, 100, 150, 200, 250, 300, 350, 400, 450, 500, 550, 600, 650, 700 or 750 mmHg. After drying, at 106 the mixture is subjected to a sweeping gas process at elevated temperature.

In one example embodiment, aluminum doping of activated carbon is carried out with aluminum acting as a wettability enhancing agent. An aluminum salt such as aluminum nitrate is converted to a thin layer of aluminum oxide on the surface of the activated carbon. The typical activated carbon as an electrode material is highly non-interactive with polar solvents that contain an organic electrolyte for supercapacitors and lithium sulphur batteries. Without being bound by theory, the activated carbon doped with aluminum oxide as described herein is believed to have interactive and adsorptive properties with polar substances resulting in improved capacitances at a fast discharge rate. The aluminum oxide content (which can be expressed as elemental aluminum content, e.g. the elemental content of the metal in the composition by weight) in the doped activated carbon can be optimized to provide a thin and conductive aluminum oxide layer.

More specifically and further without being bound by theory, it is believed that the final product of Al—O treated with sweeping gas from the aluminum, e.g. provided as aluminum nitrate, exists as an activated alumina form, and it is known that activated alumina is highly effective for adsorption of sulphur compounds, as well as being hydrophilic. It is further known that activated alumina is highly effective for adsorbing fluoride. In the examples described below, the electrolyte used in the supercapacitors contains fluoroborate ions (BF⁻₄), which may explain the observed properties of these electrodes. The results described in the examples herein suggest that Al-doped and Al and Cu-doped activated carbon formed through the sweeping gas treatment may minimize the formation of lithium polysulphides in the anode side of lithium sulphur battery applications while providing improved capacitance.

Further without being bound by theory, it is believed that copper doped in activated carbon exists as a pure copper metal form which does not have any adsorbent and hydrophilic properties. The copper-doping provides activated carbon with improved conductivity. However, the electrode with copper doped at too high a concentration may reduce the capacitance of the supercapacitor because copper may block micro-pores on and in activated carbon. Therefore, moderate levels of an electro-stabilizing agent like copper may be beneficial.

In one example embodiment, copper doping of activated carbon is carried out with copper acting as the electro-stabilizing agent. A copper salt such as copper sulphate can be converted to metallic (i.e. elemental) copper to decrease the internal resistance of the supercapacitor while minimizing blockage of the micropores of the activated carbon by the elemental copper. The content of copper in the doped activated carbon can be expressed as elemental copper content, e.g. the elemental content of the copper in the composition by weight.

In one example embodiment, aluminum and copper doping of activated carbon is carried out, with aluminum acting as the wettability enhancing agent and copper acting as the electro-stabilizing agent.

In some embodiments, the resulting activated carbon product has a carbon content of at least about 95%, including between about 90% and about 99%, including any value therebetween, e.g. 96, 97 or 98%.

In some embodiments, the resulting activated carbon product has a BET surface area as determined using nitrogen gas adsorption of at least 2500 m²/g, including at least 2600, 2700, 2800, 2900, 3000, 3100, 3200 or 3300 m²/g. In some embodiments, the resulting activated carbon product has a pore volume measured using nitrogen gas adsorption of at least 0.8 cc/g, including at least 0.85, 0.90, 0.95, 1.00, 1.05, 1.10, 1.15 or 1.20 cc/g. In some embodiments, the resulting activated carbon product has an iodine value of at least 2500 mg/g, including at least 2550, 2600, 2650, 2700, 2750, 2800, 2850, 2900, 2950, 3000, 3050, 3100, 3150 or 3200 mg/g. In some embodiments, the resulting activated carbon product has a mean particle size of less than 15 μm without micronization, including e.g. less than 14, 13, 12, 11 or 10 μm without micronization, or has a mean particle size of less than 7 μm with micronization, including e.g. less than 6 or less than 7 μm with micronization. In some embodiments, the resulting activated carbon product has a bulk density of 0.25 g/cc or higher, including e.g. 0.26, 0.27, 0.28, 0.29, 0.30, 0.31, 0.32, 0.33, 0.34, or 0.35 g/cc or higher.

In some embodiments, the activated carbon products described herein are incorporated into electrodes. FIG. 2 shows an example embodiment of a method 200 for fabricating an electrode using activated carbon. At 202, an activated carbon slurry is prepared using the activated carbon and a binder (e.g. PVF, polyvinylidenedifluoride) in a suitable solvent (e.g. N-methyl pyrrolidone, NMP). Optionally a conductivity enhancer such as graphite is added. At 204 the slurry is homogenized in any suitable manner, for example by sonication. At 206, the resultant slurry is coated on a suitable foil, e.g. aluminum foil, in any suitable manner (e.g. using a coating machine).

At 208, the electrodes are cut from the coated foil, and at 210 the electrodes are hot compressed using any suitable apparatus, e.g. a Carver lab press, e.g. by first heating the electrode to a suitable temperature such as 200° C. and then compressing the electrode e.g. at 100 MPa. At 212, the electrodes are preconditioned, for example by placing at 150° C. in a vacuum overnight. At 214, the electrodes are assembled, for example using an airtight button cell (e.g. CR2032 coin cells with a Swagelok) in an inert atmosphere, e.g. an argon-filled glove box. Two electrodes can be placed in the cell with a suitable separator positioned between them and the electrolyte (1.5 M of tetraethylammonium tetrafluoroborate (TEABF₄) dissolved in acetonitrile) can be added.

Other methods of fabricating electrodes are known to those skilled in the art and could be used in other embodiments, and the foregoing description provides guidance as to one exemplary method of fabricating electrodes and is not limiting.

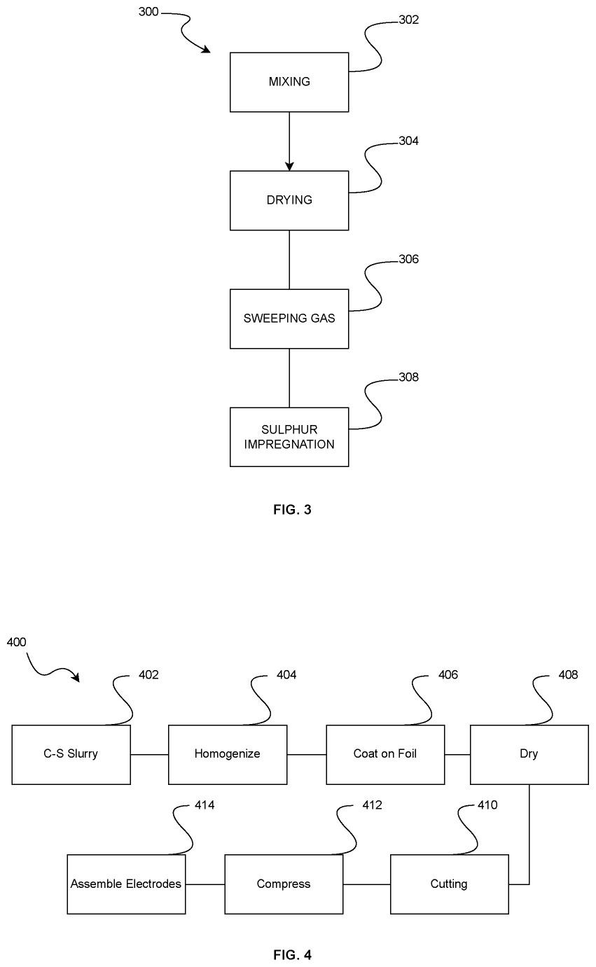

With reference to FIG. 3, an example embodiment of process 300 for preparing an activated carbon cathode for a lithium-sulphur battery is illustrated. At 302, the activated carbon is mixed with aluminum, e.g. as aluminum nitrate (Al(NO₃)₃·9H₂O) and copper, e.g. as copper sulphate (CuSO₄·5H₂O). At 304, the combined material is dried, and at 306 the material is subjected to sweeping gas treatment as described above. Finally, at 308, the activated carbon is impregnated with sulphur, for example using liquid ammonia as described in PCT publication No. WO 2021/0248245, which is incorporated by reference herein in its entirety, although any suitable method of impregnating the activated carbon could be used and other methods are known to those skilled in the art.

FIG. 4 shows an example embodiment of a process 400 for fabricating a cathode for a lithium-sulphur battery. The method illustrated in FIG. 4 is exemplary only and those skilled in the art can fabricate cathodes for lithium-sulphur batteries in any suitable manner. At 402, a carbon-sulphur composite paste is prepared using a binder (e.g. polyvinylidene difluoride) and a conductive agent (e.g. graphite) in a suitable solvent (e.g. N-methyl-2-pyrrolidone). The mixture is homogenized at 404 (e.g. by ultrasonication) and then at 406 is coated onto aluminum foil, e.g. using a doctor blade coating machine. At 408, the coated foil is dried and at 410 the coated foil is shaped as desired (e.g. cut to the desired shape) to form a cathode, which is compressed in any suitable manner at 412, e.g. using a Carver lab press. The cathode is combined with the lithium metal anode and the electrode is then assembled at 414 incorporating electrolyte (e.g. (1 M of lithium bis(trifluoromethane sulfonyl)imide (LiN(SO₂CF₃)₂) and 1% lithium nitrate in 1,2-dimethoxyethane (DME) and 1,3-dioxolane (DOXL)).

In some embodiments, a lithium sulphur battery having an electrode incorporating activated carbon is provided, wherein the electrode comprises activated carbon comprising the electro-stabilizing agent at a concentration in the range of about 0.5% to about 3.5% by weight, and/or wherein the electrode comprises activated carbon comprising the wettability enhancing agent at a concentration in the range of about 0.1% to about 0.2% by weight.

In some embodiments, a supercapacitor having an electrode incorporating activated carbon is provided, wherein the electrode comprises activated carbon comprising the electro-stabilizing agent at a concentration in the range of about 1% to about 3.5% by weight, and/or wherein the electrode comprises activated carbon comprising the wettability enhancing agent at a concentration in the range of about 0.45% to about 1.0% by weight.

In some embodiments, electrodes fabricated from activated carbon materials as described herein are incorporated into solid-state lithium batteries, e.g. lithium-sulphur batteries. In some embodiments, activated carbon materials as described herein are incorporated into capacitors or supercapacitors.

In some embodiments, electrodes fabricated from activated carbon materials as described herein are incorporated into structures and/or components of building structures for energy storage. In some embodiments, energy storage systems incorporating activated carbons prepared as described herein may offer a higher energy density than materials fabricated from conventional activated carbons, may offer a lower risk of heat buildup within a building component or a building structure than materials fabricated from conventional activated carbons, may offer a greater number of charge and discharge cycles than materials fabricated with conventional activated carbons, and/or may offer faster charging rates than materials fabricated with conventional activated carbons.

In some embodiments, energy storage systems fabricated using activated carbons as described herein are embedded into modular building components, for example panels that can be used as interior or exterior cladding for buildings, flooring, roofing, countertops, stairs or a staircase, cabinetry, or other building components. In some embodiments, the modular building components incorporate at least one supercapacitor or at least one battery having electrodes fabricated from an activated carbon material as described herein.

In some embodiments, the energy storage system is permanently incorporated into the modular building component, for example by being integrally cast within the modular building component when the modular building component is fabricated or by being permanently secured therein. In some embodiments, the energy storage system is removably incorporated into the modular building component, for example by being inserted within a compartment within the modular building component that is accessible via an access door, access panel, or other detachable or removable covering structure.

In some embodiments, the energy storage system fabricated using activated carbons as described herein is installed within a building structure during construction or erection of the building structure. The energy storage system can be incorporated into any desired part of the building structure during construction, for example a portion of the building structure that will minimize interference with the ordinary usage of the building structure, e.g. the walls, floors, ceilings or internal components thereof.

Providing a removably incorporated energy storage system allows for removal of the system for repair or replacement in the event of failure or once the energy storage system has reached the end of its useful service life. In embodiments in which the energy storage system is permanently installed, if a particular energy storage system fails or reaches the end of its useful service life, use of that particular energy storage system may be discontinued and/or that particular energy storage system may be disconnected from other energy storage systems while the physical energy storage unit remains in situ within the building structure.

In some embodiments, the energy storage system or modular building components incorporating the energy storage system are installed within a warehouse or other building structure that is of a relatively large size while not having a significant concentration of people generally situated therein (e.g. as would be the case with an office tower or residential building structure).

Individual energy storage systems that are integrated into modular building components or into buildings directly may be interconnected to one another and to the main electricity supply grid in any manner. For example, appropriate connectors and cables can be incorporated into the modular building components or into building structures to allow individual energy storage systems to be interconnected.

Depending on the particular situation in which an energy storage system is deployed, the thermal properties of the modular building component or portion of the building into which the energy storage system is incorporated can be selected. For example, in embodiments in which the energy storage system is deployed in modular building panels that also serve an insulating function, the material of the modular building panel or building component can be selected to be thermally insulating. In alternative embodiments, the material of the modular building panel or building component can be selected to be thermally conductive, to allow heat to be transferred away from the energy storage system contained therein.

In embodiments in which a surface of the modular building component or portion of the building into which the energy storage system is incorporated is to be exposed to external elements, then at least that surface of the modular building component or portion of the building that is exposed to the external elements should be weatherproof (i.e. able to withstand rain, snow, wind, sun, and other weather conditions to which it may be exposed).

In embodiments in which the energy storage systems are incorporated into modular building components, then the modular building components can be provided with any appropriate surface configuration, connectors and/or fasteners to allow assembly of the modular building components into a building structure. Any of the variety of available modular building systems could be used for this purpose. In some embodiments, the connectors or fasteners that are incorporated into the modular building components can also serve as electrical connectors, to connect the contained energy storage system to the main electrical system of the building structure.

### EXAMPLES

Certain embodiments are further described with reference to the following examples, which are intended to be illustrative and not limiting in scope.

### Example 1—Evaluation of Metal Doping of Activated Carbon

Aluminum (Al) as a wettability enhancing agent and/or copper (Cu) as an electro-stabilizing agent were added to a commercially purchased activated carbon (YP50F, Calgon Carbon Corporation, denoted as YPAC). The resultant Al- and Cu-doped YPAC was treated with a sweeping gas (containing 10% hydrogen gas and 90% nitrogen gas) at 800-900° C. for 3-6 hours. Supercapacitors fabricated with these Al and Cu doped electrodes were tested.

To conduct these studies, activated carbon YP50F obtained from Calgon Carbon Corporation and denoted in this description as YPAC was used. A process in the nature of that described with reference to FIG. 1 was used. In this study, supercapacitors having the following compositions were fabricated and tested. (1) Al-doped activated carbon: an aluminum salt (aluminum nitrate in this study) was converted to conductive Al—O with a thin layer on the resultant activated carbon. Without being bound, it is believed the Al—O doped activated carbon will have ion-interactive and adsorptive properties with polar substances resulting in improved capacitances at a fast discharging rate. An optimum Al—O content (expressed elemental Al content by weight in this example) in the doped activated carbon was determined to find a thin and conductive Al—O layer. (2) Cu-doped activated carbon: a copper salt (copper sulfate in this study) was converted to metallic (elemental) copper. Without being bound, this is believed to improve the internal resistance of the supercapacitor with a minimum degree of blockage on the micropores of YPAC by the elemental copper. In this study, optimum copper content in the doped activated carbon (expressed as elemental Cu content by weight in this example) was determined. (3) Al—Cu complex doping of activated carbon: The combination of Al and Cu doping may provide improved properties for the supercapacitor beyond that provided by Al or Cu doping alone.

### Materials and Methods

YP50F, Calgon Carbon Corporation (denoted as YPAC) was used for Al, Cu, and Al—Cu complex doping tests. The as-received YP50F (denoted YPAC) is a commercial activated carbon widely used for activated carbon-based supercapacitor applications because it has a high surface area, low ash, low resistance. The inventors treated YPAC with sweeping gas (with no metal doping) to strip out oxygen chemically bound to the YPAC. Untreated YPAC and the sweeping gas treated YPAC (denoted as YPAC+SG) were used as baselines (Baseline 1 and Baseline 2, respectively) for the comparison tests with metal-doped and sweeping gas treated YPAC.

To prepare the metal-doped activated carbon, aluminum nitrate (Al(NO₃)₃·9H₂O) and copper sulfate (CuSO₄·5H₂O) were dissolved in R.O. (reverse osmosis) water for the Al and Cu additions to YPAC, respectively. The prepared solutions ranged from 0.075% to 2.5% w/w of elemental Al (or 0.14 to 4.85% aluminum nitrate with hydrate) and from 1% to 9.2% w/w elemental Cu per liter (or 0.53% to 5.36% copper sulfate with hydrate), respectively. Specifically, the following salt solutions were prepared for doping: 0.14% Al(NO₃)₃·9H₂O (98%) for 0.075%; 0.28% Al(NO₃)₃·9H₂O (98%) for 0.15% Al; 0.57% Al(NO₃)₃·9H₂O (98%) for 0.3% Al; 0.85% Al(NO₃)₃·9H₂O (98%) for 0.45% Al; 1.44% Al(NO₃)₃·9H₂O (98%) for 0.75% Al; 1.91% Al(NO₃)₃·9H₂O (98%) for 1% Al; 4.85% Al(NO₃)₃·9H₂O (98%) for 2.5%; 0.53% CuSO₄·5H₂O (99%) for 1% Cu; 1.92% CuSO₄·5H₂O (99%) for 3.5% Cu; 2.71% CuSO₄·5H₂O (99%) for 4.9% Cu; 5.36% CuSO₄·5H₂O (99%) for 9.2% Cu.

A mass of 6 g YPAC was soaked in 45 mL of the prepared solution at room temperature for 1 hour under constant agitation conditions to add the desired Al and Cu content to YPAC, respectively. The soaked YPAC solution was dried by placing in an oven at 70° C. to remove water (until there was no observable mass change). YPAC (6 g) was also prepared using Al (45 mL) and Cu (45 mL) salt solution for Al—Cu complex doped YPAC using the same method as the Al addition. The various samples were produced as follows:
Baseline 1: As-received YPAC (Baseline 1, not treated with sweeping gas).
Baseline 2: As-received YPAC was prepared using the sweeping gas treatment (not metal-doped).
Al-doped activated carbon: an Al-salt (aluminum nitrate) was added to YPAC to prepare 0.075%, 0.15%, 0.3%, 0.45%, 1%, and 2.5% Al (based on elemental Al content by weight) in YPAC, respectively. The Al source (converted to Al₂O₃ after the sweeping gas treatment) was used as a polarizing agent (i.e. a wettability enhancing agent) to improve ionic interactions of the resultant activated carbon.
Cu-doped activated carbon: Copper sulfate was added to YPAC to prepare 1%, 3.5%, and 4.87% by weight of Cu in YPAC, respectively. The Cu source (converted to metallic copper after the sweeping gas treatment) was used as a conductive agent to further stabilize electrodes.
Al—Cu complex-doped activated carbon: aluminum nitrate and copper sulfate were added in YPAC to prepare 0.45% Al-3.51% Cu and 0.75% Al-3.51% Cu in YPAC, by weight respectively. These concentrations were selected based on the best results of the tested supercapacitors fabricated with Al-doped and Cu-doped YPAC.

The dried YPAC+Al, YPAC+Cu, and YPAC+Al-Cu products were treated with sweeping gas at a flow rate of 1 L/min, which flushed the dried YPAC+Al, YPAC+Cu, and YPAC+Al-Cu complex with a gas mixture containing 90% nitrogen and 10% hydrogen at 800-900° C. for 3-6 hours. In the furnace used in this experiment which had a diameter of 6 inches (15.24 cm) and a surface area of 182 cm², a flow rate of 1 L/min yields a flow velocity through the treated products of approximately 5.5 cm/min. During this time, the treated product is exposed to a molar excess of hydrogen relative to the estimated oxygen content of the activated carbon (about 11%). Without being bound, it is believed this sweeping gas treatment removes the oxygen groups chemically bound to activated carbon and converts conductive Al, Cu, and Al—Cu salts to conductive Al—O, Cu, and Al—Cu complex in the activated carbon, respectively. For example, thermal decomposition of Al(NO₃)₃ to Al₂O₃ and thermal decomposition of CuSO₄ to metallic Cu may occur. The former reaction may potentially involve a partial reaction with the supplied reducing gas. Further without being bound by theory, it is believed that the reducing gas may prevent conversion of copper back to copper oxide during this process. Subsequent to drying and sweeping gas treatment of the activated carbon product, one (1) mole of Al(NO₃)₃·9H₂O and CuSO₄·5H₂O becomes 0.5 mole of Al₂O₃ (or 1 mole of Al expressed as elemental Al) and 1 mole of metallic Cu in the activated carbon, respectively.

FIG. 2 shows the fabrication processes for the electrodes used in supercapacitors tested in this example. The activated carbon slurry was prepared using 80% activated carbon, 10% graphite, and 10% binder (poly-vinyldienedifluoride) and N-methyl pyrrolidone (NMP) as solvent (a mass ratio of 1 solid: 2.5 NMP for standard activated carbon or 1 solid: 2 NMP for metal-doped activated carbon) through a high energy sonication. The activated carbon slurry was coated on an aluminum foil using a coating machine. The coated aluminum foil was dried at 80° C. in a vacuum oven overnight. The dried aluminum foil was circled out to 15.0 mm in diameter. The resulting electrode was calendered at 200° C. for 2 minutes and immediately compressed at 100 MPa. The compressed electrode was preconditioned at 150° C. in a vacuum oven overnight and then the electrode was placed in an Ar-filled glove box for supercapacitor assembly. The electrode was assembled in the Ar-filled glove box using an airtight button cell (CR2032). Two identical electrodes were placed in the cell. The separator (Celgard, 25 μm) was placed between two electrodes. The electrolyte (100 μL) for this cell assembly contains 1.5 M of tetraethylammonium tetrafluoroborate dissolved in acetonitrile.

It was observed that electrodes fabricated using metal-doped activated carbon required approximately 20% less solvent to prepare a slurry suitable for coating on the aluminum foil used to fabricate the electrodes as compared with the activated carbon controls that are more reflective of the properties of standard activated carbon, and further that the metal-doped activated carbon slurry exhibited better physical properties in coating the aluminum foil. Specifically, it was observed that the metal-doped activated carbon coated layers on the aluminum foil were stronger than the activated carbon alone, as evaluated using finger squeeze tests.

Galvano charge-discharge (GCD) tests were conducted to determine the specific capacitance of the supercapacitor (tested from a slow charge and discharge (CD) of 0.5 A/g to a fast CD of 5 A/g). The GCD measurements used potential ranging from 0 to 2.3 V at various current densities ranging from 0.5 A/g to 5 A/g. The capacitance retention (%) and internal resistance (milli-ohm) were calculated based on the following equation:

$$capacitance retention ( \% ) = \frac{capacitance ( F / g ) tested at 5 A / g}{capacitance ( F / g ) tested at 0.5 A / g}$$

IR drop values were measured at a current density of 0.5-5 A/g. The internal resistance (milli-ohms) was calculated based on the correction between the IR drops and current densities.

### Results

### Al-Doped Activated Carbon

The initial performance results of supercapacitors (SCs) with baselines and Al-doped and sweeping gas-treated YPAC in Table 1 were tested at a slow discharge rate and fast discharge which are a current density of 0.5 A/g and 5 A/g, respectively. Table 1 shows the performance of SCs with the following baselines and Al-doped YPAC (+SG treatment):
YPAC (Baseline1): As-received
YPAC+3hSG (Baseline 2): As-received YPAC treated with SG at 800° C. for 3 hrs
YPAC+Al-doped+3hSG: YPAC doped at 0.075%, 0.15%, 0.3%, 0.45%, 0.75%, and 1% Al (using aluminum nitrate) and then treated with SG at 800° C. for 3 hrs, respectively.

Four cells (CR2032) of SCs were fabricated for each YPAC-based SC group. The three best cells in each Al-doped and SG-treated group were selected for comparison to baselines. The noted cells in Table 1 were not used for the comparison to determine the optimum Al-doping content. As shown in Table 1, baseline 1 and baseline 2 SCs achieved 80-84 F/g at a current density (slow discharge) of 0.5 A/g and 8 to 20 F/g at a current density (fast discharge) of 5 A/g, while Al-doped and SG-treated YPAC groups (#36, #34, and #21) performed 81-92 F/g at 0.5 A/g and 41-71 F/g at 5 A/g. These YPAC groups (#36, #43, and #21) used YPAC doped between 0.45% to 1% Al by weight based on an elemental form indicates an optimum range for Al-dopant content under these particular tested conditions. Baseline SCs had an internal resistance ranging from 44 to 94 milli-Ohm. Al-doped and SG-treated YPAC groups had an internal resistance of 23 to 62 milli-Ohm, resulting in higher capacitance retention than baseline.

TABLE 1
Initial performance of SCs with Al-doping and SG-treatment
using 0.075% to 2.5% Al.

| | | Specific | | | | | |
|---|---|---|---|---|---|---|---|
| | | applied | IR- | Internal | | | |
| | | current | drop | resistance | Capacitance | Capacitance | |
| Carbon type | Cell ID | (A/g) | (V) | (mΩ-g) | (F/g) | retention | Notes |
| #17, Y1, YP-AR | #17-5 | 0.5 | 0.219 | 133 | 76 | 100% | Not |
| (Baseline1) | | | | | | | used |
| | | 5 | 2.614 | | 0 | 0% | |
| | #17-6 | 0.5 | 0.169 | 92 | 83 | 100% | |
| | | 5 | 1.820 | | 10 | 13% | |
| | #17-7 | 0.5 | 0.138 | 75 | 84 | 100% | Best |
| | | 5 | 1.492 | | 20 | 24% | |
| | #17-8 | 0.5 | 0.168 | 94 | 80 | 100% | |
| | | 5 | 1.863 | | 8 | 10% | |
| #20, Baseline2 YP- | #20-13 | 10.5 | 0.155 | 74 | 77 | 100% | |
| SG | | 5 | 1.492 | | 18 | 24% | |
| | #20-14 | 0.5 | 0.203 | 69 | 76 | 100% | Not |
| | | | | | | | used |
| | | 5 | 1.449 | | 18 | 24% | |
| | #20-15 | 0.5 | 0.239 | 47 | 76 | 100% | |
| | | 5 | 1.081 | | 33 | 44% | |
| | #20-16 | 0.5 | 0.090 | 44 | 81 | 100% | Best |
| | | 5 | 0.883 | | 44 | 55% | |
| #23-2, | #23-2- | 0.5 | 0.521 | 63 | 68 | 100% | |
| YP + 0.075% Al + | 5 | 5 | 1.650 | | 22 | 32% | |
| 3hSG | #23-2- | 0.5 | | N/A | 0 | | Not |
| | | | | | | | charge |
| | | | | | | | able/ |
| | | | | | | | Not |
| | | | | | | | used |
| | 6 | 5 | 1.746 | | 12 | | |
| | #23-2- | 0.5 | 0.110 | 82 | 89 | 100% | |
| | 7 | 5 | 1.290 | | 29 | 32% | |
| | #23-2- | 0.5 | 0.103 | 66 | 88 | 100% | |
| | 8 | 5 | 1.584 | | 19 | 22% | |
| #29, | #29-5 | 0.5 | 0.403 | 93 | 69 | 100% | Not |
| 0.15% Al + 3hSG | | | | | | | used |
| | | 5 | 2.081 | | 3 | 4% | |
| | #29-6 | 0.5 | 0.152 | 47 | 78 | 100% | |
| | | 5 | 0.913 | | 40 | 52% | |
| | #29-7 | 0.5 | 0.157 | 42 | 77 | 100% | |
| | | 5 | 1.082 | | 37 | 47% | |
| | #29-8 | 0.5 | 0.102 | 51 | 79 | 100% | |
| | | 5 | 0.940 | | 46 | 58% | |
| #25, YP + 0.3% Al + | #25-5 | 0.5 | 0.069 | 31 | 79 | 100% | Not |
| 3hSG | | | | | | | used |
| | | 5 | 0.632 | | 55 | 69% | |
| | #25-6 | 0.5 | 0.085 | 40 | 83 | 100% | |
| | | 5 | 0.796 | | 49 | 59% | |
| | #25-7 | 0.5 | 0.109 | 53 | 83 | 100% | |
| | | 5 | 1.055 | | 40 | 48% | |
| | #25-8 | 0.5 | 0.187 | 62 | 87 | 100% | |
| | | 5 | 1.302 | | 34 | 39% | |
| #36, | #36-5 | 0.5 | 0.075 | 33 | 88 | 100% | |
| YP + 0.45% Al + | | 5 | 0.658 | | 58 | 66% | |
| 3hSG | #36-6 | 0.5 | 0.082 | 32 | 90 | 100% | Best |
| | | 5 | 0.812 | | 56 | 63% | |
| | #36-7 | 0.5 | 0.071 | 41 | 85 | 100% | Not |
| | | | | | | | used |
| | | 5 | 0.812 | | 57 | 66% | |
| | #36-8 | 0.5 | 0.065 | 41 | 92 | 100% | |
| | | 5 | 0.650 | | 62 | 67% | |
| #43, YP + 0.75% Al + | #43-1 | 0.5 | 0.094 | 44 | 86 | 100% | |
| 3hSG | | 5 | 0.883 | | 50 | 59% | |
| | #43-2 | 0.5 | 0.098 | 46 | 74 | 100% | Not |
| | | | | | | | used |
| | | 5 | 0.933 | | 40 | 54% | |
| | #43-3 | 0.5 | 0.054 | 23 | 90 | 100% | Best |
| | | 5 | 0.470 | | 71 | 79% | |
| | #43-4 | 0.5 | 0.070 | 33 | 90 | 100% | |
| | | 5 | 0.654 | | 61 | 68% | |
| #21, YP + 1% Al + | #21-5 | 0.5 | 0.090 | 46 | 80 | 100% | Not |
| 3hSG | | | | | | | used |
| | | 5 | 0.910 | | 44 | 55% | |
| | #21-6 | 0.5 | 0.098 | 49 | 82 | 100% | |
| | | 5 | 0.982 | | 41 | 50% | |
| | #21-7 | 0.5 | 0.094 | 45 | 83 | 100% | |
| | | 5 | 0.897 | | 45 | 55% | |
| | #21-8 | 0.5 | 0.069 | 31 | 86 | 100% | Best |
| | | 5 | 0.618 | | 62 | 72% | |
| #35, YP + 2.5% Al + | #35-5 | 0.5 | 0.122 | 58 | 81 | 100% | Best |
| 3hSG | | 5 | 1.173 | | 30 | 38% | |
| | #35-6 | 0.5 | 0.124 | 56 | 55 | 100% | |
| | | 5 | 1.124 | | 25 | 46% | |
| | #35-7 | 0.5 | 0.151 | 73 | 82 | 100% | |
| | | 5 | 1.465 | | 18 | 22% | |
| | #35-8 | | | | | | Not |
| | | | | | | | charge |
| | | | | | | | able/ |
| | | | | | | | Not |
| | | | | | | | used |

Table 2 shows the performance results of the best supercapacitors (SC) in the Al-doped groups compared to the baselines 1 and 2 SCs. Each SC was cycled for 300 times at 0.5 A/g and 300 cycles at 5 A/g. The Al-doped YPAC Ss performed (80-86 F/g at 0.5 A/g, 30-51 at 5 A/g, 30-79 milliohm) better than Baseline SC (79-82 F/g at 1 A/g and 19-34 at 5 A/g, and 56-74 milliohm).

TABLE 2
Long cycling performance of the best SC with Al-doping and SG-treatment using
0.45% to 1% Al after 600 cycles (300 cycles at 0.5 A/g and 300 cycles at 5 A/g)

| | | Specific | | | | |
|---|---|---|---|---|---|---|
| | | applied | | Internal | | |
| | | current | IR-drop | resistance | Capacitance | Capacitance |
| Carbon type | Cell ID | (A/g) | (V) | (mΩ-g) | (F/g) | retention |
| #17, Y1, YP-AR | #17-7 | 0.5 | 0.141 | 74 | 82 | 98% |
| (Baseline1) | | 5 | 1.471 | | 19 | 23% |
| #20, Baseline2 | #20-16 | 0.5 | 0.129 | 56 | 79 | 97% |
| (YP + 3h SG) | | 5 | 1.137 | | 34 | 42% |
| #36, YP + 0.45% | #36-6 | 0.5 | 0.097 | 42 | 86 | 95% |
| Al + 3hSG | | 5 | 0.855 | | 51 | 57% |
| #43, YP + 0.75% Al + | #43-3 | 0.5 | 0.074 | 27 | 86 | 96% |
| 3hSG | | 5 | 0.553 | | 64 | 71% |
| #21, YP + 1% Al + 3hSG | #21-8 | 0.5 | 0.104 | 71 | 80 | 93% |
| | | 5 | 1.373 | | 30 | 36% |

### Cu-Doped Activated Carbon

Table 3 shows the initial performance results of Cu-doped and sweeping gas-treated supercapacitors (SCs) in comparison to Baseline SCs. Table 3 summarizes the performance results of SCs with the following baselines and Al-doped YPAC (+SG treatment):
YPAC (Baseline1): As-received
YPAC+3hSG (Baseline 2): As-received YPAC treated with SG at 800° C. for 3 hrs
YPAC+Cu-doped+3hSG: YPAC was doped at 1.0%, 3.51%, 4.87%, and 9.2% Cu and then treated with SG at 800° C. for 3 hrs, respectively.

Table 3 indicates cells with the optimum Cu dopant content (1 to 3.5% Cu, #22 and #32) in YPAC which performed better (77-84 F/g at 0.5 A/g and 35-56 at 5 A/g, and 56-74 milliohm) than baselines SCs (79-82 F/g at 0.5 A/g and 19 to 34 at 5 A/g, and 56-74 milliohm).

TABLE 3
Initial performance of SCs with Cu-doping and SG-treatment using 1% to 9.2% Cu.

| | | Specific | | Internal | | | |
|---|---|---|---|---|---|---|---|
| | | applied | | resistance | | | |
| | | current | IR-drop | (mΩ- | Capacitance | Capacitance | |
| Carbon type | Cell ID | (A/g) | (V) | g) | (F/g) | retention | Notes |
| #17, Y1, YP-AR | #17-5 | 0.5 | 0.219 | 133 | 76 | 100% | Not used |
| (Baseline1) | | 5 | 2.614 | | 0 | 0% | |
| | #17-6 | 0.5 | 0.169 | 92 | 83 | 100% | |
| | | 5 | 1.820 | | 10 | 13% | |
| | #17-7 | 0.5 | 0.138 | 75 | 84 | 100% | Best |
| | | 5 | 1.492 | | 20 | 24% | |
| | #17-8 | 0.5 | 0.168 | 94 | 80 | 100% | |
| | | 5 | 1.863 | | 9 | 10% | |
| #20, Baseline2 | #20-13 | 0.5 | 0.155 | 74 | 77 | 100% | |
| | | 5 | 1.492 | | 18 | 24% | |
| | #20-14 | 0.5 | 0.203 | 69 | 76 | 100% | Not used |
| | | 5 | 1.449 | | 18 | 24% | |
| | #20-15 | 0.5 | 0.239 | 47 | 76 | 100% | |
| | | 5 | 1.081 | | 33 | 44% | |
| | #20-16 | 0.5 | 0.090 | 44 | 81 | 100% | Best |
| | | 5 | 0.883 | | 44 | 55% | |
| #22, YP + 1% Cu + 3 | #22-5 | 0.5 | 0.11036 | 52 | 78 | 100% | |
| hSG | | 5 | 1.04634 | | 35 | 45% | |
| | #22-6 | 0.5 | 0.10426 | 46 | 91 | 100% | Best |
| | | 5 | 0.92793 | | 44 | 48% | |
| | #22-7 | 0.5 | 0.12837 | 68 | 73 | 100% | Not used |
| | | 5 | 1.35304 | | 22 | 30% | |
| | #22-8 | 0.5 | 0.13325 | 60 | 86 | 100% | |
| | | 5 | 1.20625 | | 37 | 44% | |
| #32,YP + 3.51% Cu + | #32-5 | 0.5 | 0.096 | 59 | 81 | 100% | |
| 3hSG | | 5 | 1.153 | | 36 | 44% | |
| | #32-6 | 0.5 | 0.062 | 30 | 81 | 100% | Best |
| | | 5 | 0.593 | | 56 | 69% | |
| | #32-7 | 0.5 | 0.097 | 48 | 77 | 100% | |
| | | 5 | 0.958 | | 43 | 56% | |
| | #32-8 | 0.5 | 0.177 | 83 | 75 | 100% | Not used |
| | | 5 | 1.676 | | 16 | 21% | |
| #31, YP + 4.87% Cu + | #31-5 | 0.5 | 0.233 | 68 | 7 | 100% | |
| 3hSG | | 5 | 1.463 | | 25 | 33% | |
| | #31-6 | 0.5 | 0.113 | 55 | 80 | 100% | Best |
| | | 5 | 1.096 | | 36 | 45% | |
| | #31-7 | 0.5 | 0.149 | 79 | 75 | 100% | |
| | | 5 | 1.564 | | 16 | 21% | |
| | #31-8 | 0.5 | 0.426 | 34 | 66 | 100% | Not used |
| | | 5 | 1.030 | | 43 | 65% | |
| #30, YP + 9.20% Cu + | #30-5 | 0.5 | 0.109 | 75 | 79 | 100% | |
| 3hSG | | 5 | 1.093 | | 34 | 43% | Best |
| | #30-6 | 0.5 | 0.118 | 65 | 75 | 100% | |
| | | 5 | 1.291 | | 27 | 36% | |
| | #30-7 | 0.5 | 0.143 | 55 | 79 | 100% | |
| | | 5 | 1.495 | | 21 | 27% | |
| | #30-8 | 0.5 | | | 0 | | Not stable |
| | | 5 | | | 0 | | and not |
| | | | | | | | chargeable. |
| | | | | | | | Not used |

Table 4 shows the long cycling performance results of the best supercapacitors (SCos) in the Cu-doped groups compared to the baseline and 2 SCs. Each SC was cycled for 300 times at 0.5 A/g and 300 cycles at 5 A/g. The Cu-doped YPAC SCs performed better than Baseline SC as follows:
a Cu-doped and SG-treated Groups (#22 and #32): 78-78 F/g at 0.5 A/g, 42-51 at 5 A/g, 31-46 milliohm
Baseline SC: 79-82 F/g at 0.5 A/g and 19-34 at 5 A/g, and 56-74 milliohm

TABLE 4
Long cycling performance of the best SC with Cu-doping and SG-treatment using
1% to 4.87% Al after 600 cycles (300 cycles at 0.5 A/g and 300 cycles at 5 A/g)

| | | Specific | | | | |
|---|---|---|---|---|---|---|
| | | applied | | Internal | | |
| | | current | IR-drop | resistance | Capacitance | Capacitance |
| Carbon type | Cell ID | (A/g) | (V) | (mΩ-g) | (F/g) | retention |
| #17, Y1, YP-AR | #17-7 | 0.5 | 0.14119 | 74 | 82 | 98% |
| (Baseline1) | | 5 | 1.471448 | | 19 | 23% |
| #20, Baseline2 | #20-16 | 0.5 | 0.129 | 56 | 79 | 97% |
| | | 5 | 1.137 | | 34 | 42% |
| #22, YP + 1% Cu + | #22-6 | 0.5 | 0.079 | 46 | 78 | 91% |
| 3hSG | | 5 | 0.899 | | 42 | 49% |
| #32, YP + 3.51%% | #32-6 | 0.5 | 0.079 | 31 | 78 | 97% |
| Cu + 3hSG | | 5 | 0.634 | | 51 | 64% |
| #31, YP + 4.87% Cu + | #31-6 | 0.5 | 0.098 | 53 | 78 | 97% |
| 3hSG | | 5 | 1.047 | | 34 | 42% |

### Al—Cu Complex Doping of Activated Carbon

There are advantages of Al and Cu doping, respectively. Without being bound by theory, low Al-doping provides the electrode with better interactive and adsorptive properties with polar substances. A high Cu-doping gives improved conductivity of the electrode for SC applications. Table 5 shows the sweeping gas treatment for the conversion of the Al—Cu mixture to the conductive Al—Cu complex. Initially, a volume of 45 mL each was added in a crucible and the prepared crucible (a total of 90 mL) was placed in a 70° C. oven until all water was removed. The dried solid mixture was treated with sweeping gas at 800-900° C. for 3-6 hrs. These trials were conducted with the mixture solution alone (without activated carbon) to determine optimum temperature and retention time prior to metal-doping the activated carbon.

Trials 1 and 2 show the mixture treated with sweeping gas for 3 hrs and 6 hrs at 800° C. The resultant product from Trial 1 (800° C. for 3 hrs) was not conductive, and the Trial 2 product became conductive after the SG treatment at 800° C. for 6 hrs. The resultant product from Trial 3 (900° C. for 3 hrs) was conductive. The Trial 3 product had 323% relative resistance based on the MTI graphite. The Trial 4 product achieved greater conductivity after the sweeping gas treatment at 900° C. for 6 hrs and had 180% relative resistance.

TABLE 5
Conductiveness of Al—Cu complex after sweeping gas treatment.

| Process conditions | Trial 1 | | Trial 2 | | Trial 3 | | Trial 4 | |
|---|---|---|---|---|---|---|---|---|
| Solution type and | 45 mL of | | 45 mL of | | 45 mL of | | 45 mL of | |
| mixing volume | 0.45%-Al mixed | | 0.45%-Al mixed | | 0.45%-Al mixed | | 0.45%-Al mixed | |
| | with 45 mL of | | with 45 mL of | | with 45 mL of | | with 45 mL of | |
| | 3.51% Cu | | 3.51% Cu | | 3.51% Cu | | 3.51% Cu | |
| Drying temperature | 70° | C. | 70° | C. | 70° | C. | 70° | C. |
| Temperature of SG | 800° | C. | 800° | C. | 900° | C. | 900° | C. |
| treatment after drying | | | | | | | | |
| Retention time of SG | 3 | hr | 6 | hr | 3 | hr | 6 | hr |
| treatment | | | | | | | | |

| | | | | |
|---|---|---|---|---|
| Conduciveness tested | No | No | Yes | Yes |
| using a multimeter | | | | |
| Relative resistance | Not tested | Not tested | 323% | 180% |
| based on MTI graphite | | | | |

Table 6 examines the mass balance of the mixture solution. Table 6 compares a collected mass of the Trial 4 product with a theoretical mass based on the initial mass of aluminum nitrate and copper sulfate which are fully converted to the Al—Cu complex (without being bound by theory, believed to be Al₂O₃ homogeneously blended with elemental copper). Table 6 shows that the calculated mass of the product agreed with the collected mass of the Trial 4 product.

TABLE 6
Mass balance of Al-Cu complex after sweeping gas treatment.

| | | | Mass (g) theoretically calculated based on the added | | | |
|---|---|---|---|---|---|---|
| | | | solution | | | |
| | | | After dehydration (drying) | | | |
| | | | Salt with | | After SG | |
| | | Salt | hydrate (g of Al | Anhydrous salt | treatment | |
| | Solution (g) | concentration | (NO₃)₃-9H₂O or | (g of Al (NO₃)₃ | Product mass | |
| Salt type | added in | (wt. %) in the | CuSO₄-5H₂O) | or CuSO₄) in | (g of Al-Cu | Collected mass |
| used | the crucible | solution | in the crucible | the crucible | complex) | of SG treatment |
| Al-salt | 45.02 | 0.83% | 0.375 | 0.213 | 0.051 | NA |
| solution | | | | | | |
| Cu-salt | 45.027 | 3.07% | 1.381 | 0.597 | 0.351 | NA |
| solution | | | | | | |
| Sum (g) | 90.047 | NA | 1.755 | 0.810 | 0.402 | 0.407 |
| in the | | | | | | |
| crucible | | | | | | |

Table 7 summarizes the initial performance results of Al and Cu-doped and sweeping gas-treated supercapacitors (SCs) in comparison to Baseline SCs. Table 7 shows the initial performance results produced by the following trials:
YPAC (Baseline1, #17): As-received.
YPAC+3hSG (Baseline 2, #20): As-received YPAC treated with SG at 800° C. for 3 hrs.
YPAC+0.45% Al+3.51% Cu-doped+3hSG900 (#38-1): YPAC doped using 0.45% Al and 3.51% Cu and then treated with SG at 900° C. for 3 hrs.
YPAC+0.45% Al+3.51% Cu-doped+6hSG900 (#42): YPAC was doped using 0.45% Al and 3.51% Cu and then treated with SG at 900° C. for 6 hrs, respectively.
YPAC+0.75% Al+3.51% Cu-doped+6hSG900 (#46): YPAC was doped using 0.75% Al and 3.51% Cu and then treated with SG at 900° C. for 6 hrs, respectively.

Groups #42 and #46 achieved the following results which are better than baseline 1 and 2.
Al and Cu-doped and SG-treated Groups (#42 and #46): 87-92 F/g at 0.5 A/g, 37-64 at 5 A/g, 29-51 milliohm.
Baseline SC: 79-82 F/g at 0.5 A/g and 19-34 at 5 A/g, and 56-74 milliohm.
   The group #38-1 yielded a similar result to Baseline 2, suggesting the sweeping gas treatment time of 3 hrs was not long enough for Al—Cu-doping in YPAC under the tested conditions.

TABLE 7
Initial performance of SCs with Al-Cu-doping and sweeping gas-treatment.

| | | Specific | | | | | |
|---|---|---|---|---|---|---|---|
| | | applied | IR- | Internal | | | |
| | | current | drop | resistance | Capacitance | Capacitance | |
| Carbon type | Cell ID | (A/g) | (V) | (mΩ-g) | (F/g) | retention | Notes |
| #17, Y1, YP-AR | #17-5 | 0.5 | 0.219 | 133 | 76 | 100% | Not |
| (Baseline1) | | 5 | 2.614 | | 0 | 0% | used |
| | #17-6 | 0.5 | 0.169 | 92 | 83 | 100% | |
| | | 5 | 1.820 | | 10 | 13% | |
| | #17-7 | 0.5 | 0.138 | 75 | 84 | 100% | Best |
| | | 5 | 1.492 | | 20 | 24% | |
| | #17-8 | 0.5 | 0.168 | 94 | 80 | 100% | |
| | | 5 | 1.863 | | 8 | 10% | |
| #20, Baseline2 | #20-13 | 0.5 | 0.155 | 74 | 77 | 100% | |
| | | 5 | 1.492 | | 18 | 24% | |
| | #20-14 | 0.5 | 0.203 | 69 | 76 | 100% | Not |
| | | | | | | | used |
| | | 5 | 1.449 | | 18 | 24% | |
| | #20-15 | 0.5 | 0.239 | 47 | 76 | 100% | |
| | | 5 | 1.081 | | 33 | 44% | |
| | #20-16 | 0.5 | 0.090 | 44 | 81 | 100% | Best |
| | | 5 | 0.883 | | 44 | 55% | |
| #38-1, | #38-1-1 | 0.5 | 0.100 | 65 | 78 | 100% | |
| 0.45% Al + 3.51% Cu + 3h | | 5 | 1.201 | | 32 | 41% | |
| SG900 | #38-1-2 | 0.5 | 0.091 | 36 | 78 | 100% | |
| | | 5 | 0.741 | | 48 | 61% | |
| | #38-1-3 | 0.5 | 0.095 | 61 | 77 | 100% | Not |
| | | | | | | | used |
| | | 5 | 1.265 | | 29 | 37% | |
| | #38-1-4 | 0.5 | 0.102 | 50 | 77 | 100% | Best |
| | | 5 | 0.999 | | 40 | 52% | |
| #42, | #42-1 | 0.5 | 0.181 | N/A | 87 | 100% | Not |
| 0.45% Al + 3.51% Cu + 6h | | | | | | | used |
| SG900 | | 5 | Note 1 | | 0 | 0% | |
| | #42-2 | 0.5 | 0.098 | 50 | 92 | 100% | |
| | | 5 | 0.998 | | 49 | 53% | |
| | #42-3 | 0.5 | 0.077 | 42 | 92 | 100% | Best |
| | | 5 | 0.837 | | 56 | 60% | |
| | #42-4 | 0.5 | 0.064 | 29 | 96 | 110% | |
| | | 5 | 0.590 | | 64 | 73% | |
| #46, | #46-1 | 0.5 | 0.115 | 51 | 88 | 100% | |
| 0.75% Al + 3.51% Cu + 6h | | 5 | 1.028 | | 44 | 51% | |
| SG900 | #46-2 | 0.5 | 0.076 | 34 | 91 | 100% | Best |
| | | 5 | 0.692 | | 58 | 64% | |
| | #46-3 | 0.5 | 0.097 | 42 | 71 | 100% | Not |
| | | | | | | | used |
| | | 5 | 0.860 | | 47 | 67% | |
| | #46-4 | 0.5 | 0.066 | 51 | 102 | 100% | Unstable |
| | (Note 2) | 5 | 0.546 | | 74 | 46% | |

Notes:
1. #42-1 cell was not charged at the initial tests, and it performed 97 F/g at 0.5 A/g and 57 F/g at 5 A/g after 2 days rest.
2. #46-4 cell was unstable at the initial tests. It became stable after 1 week rest and achieved 111 F/g at 0.5 A/g and 64 F/g at 5 A/g (internal resistance of 51 mΩ).

Table 8 shows the long cycling performance results of the best SC in the Al and Cu-doped groups compared to the baseline 1 and 2 SCs. Each SC group achieved the following results after 300 cycles at 1 A/g and 300 cycles at 10 A/g. The Al and Cu-doped YPAC SCs performed better than Baselines SC as follows:
Al and Cu-doped and sweeping gas-treated Groups (#42-2 and #46-2): 86-90 F/g at 0.5 A/g, 53-57 at 5 A/g, 36-38 milliohm.
Baselines SC: 79-82 F/g at 0.5 A/g and 19-34 at 5 A/g, and 56-74 milliohm.

TABLE 8
Long cycling performance of the best supercapacitors with Al and Cu-doping and
sweeping gas-treatment using optimum Al and Cu content after 600 cycles (300 cycles at
0.5 A/g and 300 cycles at 5 A/g).

| | | Specific | | | | |
|---|---|---|---|---|---|---|
| | | applied | | Internal | | |
| | | current | IR-drop | resistance | Capacitance | Capacitance |
| Carbon type | Cell ID | (A/g) | (V) | (mΩ-g) | (F/g) | retention |
| #17, Y1, YP-AR (Baseline1) | #17-7 | 0.5 | 0.14119 | 74 | 82 | 98% |
| | | 5 | 1.471448 | | 19 | 23% |
| #20, Baseline2 | #20-16 | 0.5 | 0.129 | 56 | 79 | 97% |
| | | 5 | 1.137 | | 34 | 42% |
| #38-1, | #38-1- | 0.5 | 0.131 | 59 | 66 | 86% |
| 0.45% Al + 3.51% Cu + | 4 | 5 | 1.194 | | 31 | 41% |
| 3hSG900 | | | | | | |
| #42, | #42-2 | 0.5 | 0.078 | 38 | 92 | 101% |
| 0.45% Al + 3.51% Cu + | | 5 | 0.766 | | 53 | 58% |
| 6hSG900 | | | | | | |
| #46, | #46-2 | 0.5 | 0.073 | 36 | 90 | 98% |
| 0.75% Al + 3.51% Cu + | | 5 | 0.727 | | 57 | 62% |
| 6hSG900 | | | | | | |

In summary, the following performance data were confirmed by the foregoing examples:
Baseline2-based supercapacitors achieved similar performance to Baseline1 at the slow discharge of 0.5 A/g (low amperage loading), while Baseline2-based supercapacitor performed significantly better than Baseline 1 at the fast discharge of 5 A/g (high amperage loading).
The YPAC+Al+SG based SC achieved better performance than Baselines 1 and 2.
The YPAC+Cu+SG based SC performed better performance at the fast discharge of 10 A/g than Baselines 1 and 2.
The YPAC+Al+Cu+SG based SC achieved the best results among compared SCs.
The optimum content of the Al—Cu mixture in YPAC was any concentration within the optimum range of 0.45-1% Al and 1-3.5% Cu by mass.

Table 9 summarizes results for various experimental samples to demonstrate how treatment with sweeping gas and embedment of aluminum and copper enhance the capacitance of the tested capacitors. The metal-doped activated carbon was found to produce capacitors with 2.9 times greater area and volumetric capacitance than capacitors fabricated from regular activated carbon.

TABLE 9
Area and volumetric capacitance for selected experimental examples.

| | | | Capacitance |
|---|---|---|---|
| | Areal capacitance | | increase (%) at |
| | (F/cm²) at | (F/cm²) at | fast discharge |
| Cell ID | 0.5 A/g | 5 A/g | (5 A/g) |
| Benchmark YPAC (Baseline 1, | 57.3 | 13.3 | 100% |
| #17-7 cell in Table 8) | | | |
| Benchmark YPAC + SG (Baseline | 61.1 | 26.3 | 197% |
| 2, #20-16 cell in Table 8) | | | |
| YPAC + 0.75% Al + 3.51% CuSG900 | 62.8 | 39.7 | 298% |
| (#46-2 cell in Table 8) | | | |
| | | | Capacitance |
| | Volumetric capacitance | | increase (%) at |
| | (F/cm³) at | (F/cm³) at | fast discharge |
| Cell ID | 0.5 A/g | 5 A/g | (5 A/g) |
| Benchmark YPAC (Baseline 1, | 19.1 | 4.4 | 100% |
| #17-7 cell in Table 8) | | | |
| Benchmark YPAC + SG (Baseline | 20.4 | 8.8 | 197% |
| 2, #20-16 cell in Table 8) | | | |
| YPAC + 0.75% Al + 3.51% CuSG900 | 20.9 | 13.2 | 298% |
| (#46-2 cell in Table 8) | | | |

In conclusion, the foregoing examples demonstrate that the sweeping gas treatment together with Al and Cu-doping improved the performance of supercapacitors fabricated from activated carbon (YPAC). Without being bound, it is believed that the sweeping gas treatment with Al-doping (Al₂O₃-doping) and Cu-doping can improve ionic interactions and provide improved resistance properties for activated carbon-based supercapacitors with high capacitance and high stability. A low Al-doping improves the wettability of the electrode by providing the electrode with improved hydrophilic and adsorptive properties. A high Cu-doping gives improved conductivity of the electrode for supercapacitor applications. Without being bound by theory, the electrolyte used to test the supercapacitors in these examples contains the conductive salt tetraethylammonium tetrafluoroborate, TEABF₄, dissolved in acetonitrile, which is a hydrophilic solvent. The activated carbon produced by the sweeping gas treatment is highly hydrophobic due to the removal of oxygen-based functional groups. Thus, the wettability (i.e. hydrophilicity) of the electrode is poor due to the hydrophobic surface of the activated carbon. This poor wettability is believed to contribute to a poor ion mobility of TEABF₄ in the activated carbon electrodes, resulting in a poor internal resistance of the activated carbon based supercapacitors. Doping with aluminum that is believed to be converted to an Al₂O₃ or AlO form improves the wettability of the electrolyte with the surface of the activated carbon electrode, thereby improving the performance of the supercapacitor.

Without limitation, embodiments can include the following aspects:
An activated carbon product doped with aluminum and treated with a sweeping gas process at elevated temperature in which the elemental aluminum concentration ranges from 0.45% to 1% by weight (e.g. present as an Al₂O₃ form) in activated carbon.
An activated carbon product doped with copper and treated with a sweeping gas process at elevated temperature in which the elemental copper concentration ranges from 1% to 3.5% by weight.
An activated carbon product doped with both aluminum and copper and treated with a sweeping gas process at elevated temperature in which the elemental concentrations of aluminum and copper are from 0.45% to 1% by weight and less than 3.5% by weight, respectively (or wherein the elemental concentration of copper is between 1% and 3.5% by weight).
The coating of activated carbon doped with a wettability enhancing agent on aluminum foil for electrode fabrication needs 20% less solvent than typical activated carbon when used as an electrode material.

### Example 2—Supercapacitors Prepared with Metal-Doped and SG-Treated LAAC

Activated carbon made from lignin-A (“LAAC”) (micronized) was treated with sweeping gas treatment, and the sweeping gas-treated LAAC was used as a baseline for supercapacitor performance tests in comparison to supercapacitors with metal-doped+SG-treated LAAC. Based on the optimum dopant content using YP50AC, LAAC was doped with the Al source in a range from 0.45% to 1.5% Al and with 3% Cu followed by sweeping gas (SG) treatment.

Supercapacitors were assembled with baseline LAAC and metal-doped+SG-treated LAAC. Four (4) cells were assembled for each group and tested at a low amperage loading of 0.5 A/g and a high amperage loading of 5 A/g. Each cell was tested for initial capacitance and internal resistance. The best cell in each group was selected for 600 cycle tests based on the high capacitance with low internal resistance.

Table 10 shows the properties of the SG-LAAC (micronized). The mean sizes of the milled LAAC were 5.8 μm. The milled LAAC was used for metal-doping and SG-treatment. The milled LAAC had 97.5% carbon content and 0.29% ash content. Iodine number for the milled LAAC was 3,050 mg/g which was slightly decreased before milling. The BET surface of the milled LAAC was computed to be 2,900 m²/g using a correlation (y=0.9374x+47.781, R²=0.9416) between Iodine values and BET surface area values (based on nitrogen adsorption) measured from previous activated-carbon samples. The relative electrical resistance of the milled LAAC is within the typical value (225%).

TABLE 10
Properties of the SG-LAAC (micronized)
used for metal-doping and SG-treatment.

| | | | Surface area (m²/g) | Relative | |
|---|---|---|---|---|---|
| | | | calculated using | electrical | Mean |
| Carbon | Ash | Iodine | iodine values | resistance | particle |
| (%) | (%) | (mg/g) | (Note) | (%) | size (μm) |
| 97.5 | 0.29 | 3,050 | 2,900 | 225% | 5.8 |

(Note):
Surface area (m²/g) was calculated using a correlation between Iodine values and BET surface area values.

Table 11 summarizes the initial capacitance and initial internal resistance of the supercapacitors (SCs). Group #111 is the baseline SCs with the SG-treated LAAC. Groups #112, #113, #124, #122, and #123 are SCs with metal doped and SG-treated LAAC which were compared with the baseline SCs. The worst cell in each group was excluded to select the best cell based on internal resistance and capacitance.

At the low amperage loading (0.5 A/g), the baseline SCs (with the SG-treated LAAC) achieved the best performance (144-155 F/g) in comparison with SCs with doped and SG-treated LAAC (127 to 155 F/g from Groups #112, #113, #124, #122, and #123), while groups #113 and #124 SCs consistently performed better than the baseline SCs (106-123 F/g) at the high amperage loading. Groups #113 and #124 SCs had LAAC-based electrodes which were doped with 0.75% Al+3% Cu and 1% Al+3% Cu by weight, respectively. These doped LAACs were treated with SG before the SC assembly.

The initial internal resistance values (28-62 mΩ-g) of SC groups with metal-doped and SG-treated LAAC were tested to be lower (or better) than the baseline SCs (43-62 mΩ-g) except for Group #112 (30-92 mΩ-g). These low internal resistance values of the doped and SG-treated SC groups are responsible for achieving higher capacitance values than the baseline SCs at the high amperage loading.

These results also suggest that doped Al and Cu sources may partially block the surface of the SG-treated LAAC resulting in slightly lower capacitance than the baseline SCs at the low amperage loading. Based on the consistent results of capacitance and internal resistance, the best cell from the baseline and other groups was selected for 600 cycle tests except for group #112 which performed inconsistently with poor internal resistance.

TABLE 11
Initial performance of the SG-treated LAAC in comparison with doped and SG-
treated LAAC.

| | | Amperage | | Internal | | |
|---|---|---|---|---|---|---|
| | | loading | | resistance | Capacitance | |
| Type of LAAC | Cell ID | (A/g) | IR drop (V) | (mΩ-g) | (F/g) | Note |
| #111 | #111-5 | 0.5 | 0.057 | 52 | 155 | |
| (Baseline, SG-treated | | 5 | 0.525 | | 120 | |
| LAAC) | #111-6 | 0.5 | 0.077 | 72 | 155 | Worst and excluded |
| | | 5 | 0.726 | | 102 | |
| | #111-7 | 0.5 | 0.067 | 62 | 144 | |
| | | 5 | 0.624 | | 106 | |
| | #111-8 | 0.5 | 0.050 | 43 | 152 | Best and selected |
| | | 5 | 0.443 | | 123 | for 600 cycle test |
| #112: | #112-5 | 0.5 | 0.175 | 79 | 98 | Worst and excluded |
| 0.45% Al + 3% Cu + SG + | | 5.0 | 0.890 | | 64 | |
| LAAC | #112-6 | 0.5 | 0.111 | 92 | 141 | |
| | | 5.0 | 0.941 | | 78 | |
| | #112-7 | 0.5 | 0.038 | 30 | 139 | |
| | | 5.0 | 0.305 | | 121 | |
| | #112-8 | 0.5 | 0.064 | 51 | 133 | |
| | | 5.0 | 0.522 | | 104 | |
| #113: | #113-5 | 0.5 | 0.050 | 38 | 129 | |
| 0.75% Al + 3% Cu + | | 5.0 | 0.394 | | 105 | |
| LAAC | #113-6 | 0.5 | Not tested | | Not tested | Worst and excluded |
| | | 5.0 | Not tested | | Not tested | (poorly assembled) |
| | #113-7 | 0.5 | 0.048 | 40 | 155 | |
| | | 5.0 | 0.408 | | 128 | |
| | #113-8 | 0.5 | 0.044 | 36 | 135 | Best and selected |
| | | 5.0 | 0.366 | | 112 | for 600 cycle test |
| #124: | #124-1 | 0.5 | 0.039 | 33 | 128 | |
| 1% Al + 3% Cu + SG + | | 5 | 0.337 | | 107 | |
| LAAC | #124-2 | 0.5 | 0.066 | 62 | 129 | Worst and excluded |
| | | 5 | 0.621 | | 93 | |
| | #124-3 | 0.5 | 0.039 | 30 | 154 | |
| | | 5 | 0.309 | | 133 | |
| | #124-4 | 0.5 | 0.034 | 26 | 135 | Best and selected |
| | | 5 | 0.266 | | 115 | for 600 cycle test |
| #122: | #122-1 | 0.5 | 0.034 | 30 | 121 | Worst and excluded |
| 1.25% Al + 3% Cu + SG + | | 5.0 | 0.304 | | 106 | |
| LAAC | #122-2 | 0.5 | 0.036 | 28 | 127 | |
| | | 5.0 | 0.288 | | 113 | |
| | #122-3 | 0.5 | 0.037 | 26 | 129 | Best and selected |
| | | 5.0 | 0.267 | | 113 | for 600 cycle test |
| | #122-4 | 0.5 | 0.031 | 21 | 157 | |
| | | 5.0 | 0.224 | | 135 | |
| #123: | #123-1 | 0.5 | 0.043 | 32 | 142 | |
| 1.5% Al + 3% Cu + SG + | | 5.0 | 0.327 | | 123 | |
| LAAC | #123-2 | 0.5 | 0.042 | 34 | 128 | |
| | | 5.0 | 0.352 | | 105 | |
| | #123-3 | 0.5 | 0.044 | 30 | 123 | Worst and excluded |
| | | 5.0 | 0.342 | | 103 | |
| | #123-4 | 0.5 | 0.038 | 33 | 138 | Best and selected |
| | | 5.0 | 0.310 | | 113 | for 600 cycle test |

Table 12 shows the capacitance and internal resistance of the best SC that was selected from the baseline and other groups except for group #112 and then tested after 300 cycles at the low amperage loading and 300 cycles at the high amperage loading. The baseline SCs (150 F/g) performed better than the other groups (117-126 F/g) at the low amperage, while the baseline SC achieved a lower capacitance (97 F/g) at the high amperage loading than groups #113 and #124 (109-113 F/g).

The internal resistance of groups #112, #113, and #124 SCs ranged from 28 to 33 mΩ-g which was much lower than the baseline SCs (78 mΩ-g). The internal resistance of groups #112, #113, and #124 SCs has small changes after 600 cycles, while the internal resistance of the baseline SCs became worse indicating that the baseline SCs are not stable at the high amperage loading.

Since groups #113 and #124 consistently yielded better capacitance (109-113 F/g or 12%-16% higher) and lower internal resistance than the baseline SCs, optimum metal dopant content for this particular activated carbon under the tested conditions appears to be 0.75% Al+3% Cu and 1% Al+3% Cu for LAAC. This optimum content is slightly higher than optimal dopant content determined for YP50AC (0.45% Al+3% Cu and 0.75% Al+3% Cu).

It is also noted that the SG-treated LAAC has a low electrical resistance (225%) and super high surface area (2,900 m²/g) that are much better material performance properties than YP50AC (434% and 1,876 m²/g of SG-treated YP50AC). Without being bound by theory, the electrode enhancement with metal doping may improve the properties of YP50AC more than LAAC, which already has relatively low resistance and high surface area (or high ion-adsorptive capability) that are sufficient for supercapacitor (SC) applications at a low amperage loading.

TABLE 12
600 cycle performance of the SG-treated LAAC
in comparison with doped and SG-treated LAAC.

| | | Amperage | | Internal | Capac- |
|---|---|---|---|---|---|
| | | loading | IR drop | resistance | itance |
| Type of LAAC | Cell ID | (A/g) | (V) | (mΩ-g) | (F/g) |
| Baseline: SG- | #111-8 | 0.5 | 0.088 | 78 | 150 |
| treated LAAC | | 5 | 0.789 | | 97 |
| 0.75% Al + 3% | #113-8 | 0.5 | 0.039 | 32 | 126 |
| Cu + SG + LAAC | | 5 | 0.326 | | 109 |
| 1% Al + 3% | #124-4 | 0.5 | 0.034 | 28 | 127 |
| Cu + SG + LAAC | | 5.0 | 0.284 | | 113 |
| 1.25% Al + 3% | #122-3 | 0.5 | 0.049 | 31 | 121 |
| Cu + SG + LAAC | | 5.0 | 0.457 | | 98 |
| 1.5% Al + 3% | #123-4 | 0.5 | 0.043 | 32 | 117 |
| Cu + SG + LAAC | | 5.0 | 0.334 | | 101 |

The following findings were made based on this study:
The optimum Al and Cu dopant content under tested conditions were determined to be 0.75% Al+3% Cu and 1% Al+3% Cu for LAAC which is slightly higher than dopant content for YP50AC (0.45% Al+3% Cu and 0.75% Al+3% Cu).
SCs with the optimum Al—Cu doped and SG-treated LAAC were demonstrated to be 12%-16% higher capacitance than the baseline SCs (SCs with SG-treated LAAC) at a high amperage loading which is important for high amperage SCs (5 A/g).
The optimum Al—Cu doped and SG-treated LAAC electrode does not improve capacitance at a low amperage loading (0.5 A/g).

Without being bound by theory, it is believed that the electrode enhancement with metal doping may improve YP50AC more than LAAC because LAAC already has low resistance and high surface area (or high ion-adsorptive capability that are enough for SC applications (at a low amperage loading).

### Example 3—LiSBs with Metal-Doped, SG-Treated and S-Impregnated LAAC

LiS batteries use sulphur as the active material in the cathode which is reduced to polysulfide intermediates during the discharge mode. These polysulfides that are polar and highly soluble in the electrolyte leak from the cathode to the anode (known as the shuttle effect). The diffused polysulfides are further reduced to the low order sulfides and deposit as a passive solid, which is irreversible. As a result, the LiS battery fails to provide the theoretical energy density. This study employs highly ion-adsorptive AC with micro-pores (<2 nm in width) and a metal-doping technique to trap polysulfides in the cathode to overcome the shuttle effect.

The main objective of this study was to optimize the content of Al—Cu mixture in the cathode of LiS batteries which contain non-conductive sulphur. To improve the interaction of the lignin-based activated carbon cathode with polar-based electrolyte in the LiSB system while minimizing loss of electrical conductivity by the sulphur impregnation after the doping and SG treatment, LAAC was doped at a lower content of Al—Cu mixture for LiSBs than the optimum Al—Cu mixture for supercapacitors. Without being bound by theory, it is believed that the sulphur impregnation of the activated carbon to generate the cathode for the LiS battery may further increase the resistance of the cathode. Sulphur is electrically insulating, and the micropore space of the activated carbon is occupied by the impregnated sulphur.

Lignin-based activated carbon or LAAC was used for Al—Cu mixture doping. The LAAC was produced using lignin A obtained from a lignin recovery plant in Alberta, Canada, which has a high surface area, low ash, and low resistance. The activated carbon was metal-doped following the procedure illustrated in FIG. 3, with drying being conducted at a temperature of 60-80° C.

For this example, the LAAC was doped with an Al-doping range from 0 to 0.45% Al and at 3% Cu. To dope the desired content of the Al—Cu mixture, LAAC (6 g) was also added in 45 mL aluminum nitrate (0.28% Al(NO₃)₃·9H₂O (98%) for 0.15% w/w Al; 0.57% Al(NO₃)₃·9H₂O (98%) for 0.3% w/w Al; and 0.85% Al(NO₃)₃·9H₂O (98%) for 0.45% w/w Al) and 45 mL copper sulfate (1.63% CuSO₄·5H₂O (99%) for 3% w/w Cu) solutions, respectively. The soaked LAAC solution was placed in an oven at 70° C. to remove water until no further mass change was observed. The following metal-doped LAAC samples were prepared for the SG treatment:
Baseline: LAAC-treated with SG
Al—Cu mixture doping: Aluminum nitrate and copper sulfate were added in LAAC to prepare the following content of Al—Cu mixture
   0.15% Al plus 3% Cu (w/w)
   0.3% Al plus 3% Cu (w/w)
   0.45% Al plus 3% Cu (w/w)

The dried LAAC and Al—Cu doped LAAC products were treated with sweeping gas containing 90% nitrogen and 10% hydrogen. The sweeping gas flushed the dried LAAC and Al—Cu doped LAAC products at a flow rate of 100 mL/min in a 6 inch tube under temperature of 900° C. for 6 hours. This sweeping gas treatment removes the oxygen groups chemically bound to the activated carbon and converts the Al—Cu salts to a conductive Al—Cu mixture in the activated carbon. Through this treatment, one (1) mole of Al(NO₃)₃·9H₂O and CuSO₄·5H₂O becomes 0.5 mole of Al₂O₃ (or 1 mole of Al expressed as elemental Al) and 1 mole of metallic Cu, respectively.

The sulphur impregnation process involves the dissolution of granular S° (elemental sulphur) in liquid ammonia (LNH₃) under the ammonia vapor pressure (approx. 110 psig at room temperature), for example as described in PCT publication No. WO 2021/248245. The dissolved S° in LNH₃ is then adsorbed onto LAAC by simple immersion of the carbon in the solution. S-impregnated activated carbon can then be collected after the sample is removed from the pressurized environment and at that time vaporization of the LHN₃ at room temperature (RT) occurs. The vaporization leaves the sulphur behind and the impregnated carbon is ready to use as a cathode material for LiS batteries. The following cathode materials were prepared:
Baseline: LAAC treated with SG containing 63.12% sulphur
0.15% Al and 3.0% Cu-doped and SG-treated LAAC containing 71.0% sulphur w/w
0.3% Al and 3.0% Cu-doped and SG-treated LAAC containing 67.3% sulphur w/w
0.45% Al and 3.0% Cu-doped and SG-treated LAAC containing 65.97% sulphur w/w

### LiSB Assembly

In the fabrication method for the cathode of the LiSB (according to an example process as illustrated in FIG. 4), the S⁺-impregnated activated carbon, polyvinylidene difluoride (PVDF) (binder), and graphite (as a conductive agent) were suspended in a paste using N-methyl-2-pyrrolidone (NMP) using a mass ratio of 60:20:20, respectively. The carbon-sulphur (C—S) composite paste was homogenized using ultrasonication for 20 minutes and then coated onto Al foil using a doctor blade coating machine. The Al foil, now thinly coated with the C—S composite, was dried under vacuum at 60° C. for 24 h for NMP removal. 15 mm diameter disks were punched out as the cathode. A 15 mm diameter lithium disc, used as the anode material, was punched out of a lithium strip (40 mm wide and 0.6 mm thick) in an argon-filled glovebox and the electrodes were assembled using CR 2032 (a swagelock type coin cell) in the argon-filled glovebox. The electrolyte (containing 1 M of lithium bis(trifluoromethane sulfonyl)imide (LiN(SO₂CF₃)₂) and 1% lithium nitrate in 1,2-dimethoxyethane (DME) and 1,3-dioxolane (DOXL)) was added to each cell using an electrolyte volume per mg of sulphur in the cathode ranging from 40 to 115 μL.

### Performance Tests of LiSBs

Galvanostatic charge-discharge (GCD) was tested for determination of the specific capacity (mAh/g) of the Li—S battery with the lignin-based cathode. The GCD measurements used potential ranging from 1.7 to 3.0 V (100% DoD, depth of discharge) at a current density of 1.0 Coulomb (C)/g or 1,675 mA/g. LiS batteries were also 500 times cycled for cyclability using the GCD method. The capacity and capacity retention were calculated using the following equation:

$$Capacity ( mAh / g ) from GCD = Applied current ( A ) \times discharge time ( sec ) / 60 \times 60 \times mass of sulphur in the cathode ( g )$$

$$Capacity retention ( \% ) = Capacity at a number of cycles tested with 100 \% DoD / initial capacity at the 1 st cycle tested with 100 \% DoD$$

### Properties of SG-Treated LAAC Used for Sulphur Impregnations

Table 13 shows the major chemical and adsorptive properties (iodine values and surface area) of LAAC. The SG-treated LAAC had a carbon content of 98.1%, an iodine value of 3,140 mg/g, and a surface area of 3,203 m2/g with a mean pore size of 1.13 nm, and 14.3 μm mean particle size.

TABLE 13
Property comparison of LAAC.

| | Carbon | Iodine | | | Mean |
|---|---|---|---|---|---|
| | content | value | BET Surface | Mean pore | particle |
| Carbon ID | (%) | (mg/g) | area (m2/g) | size (nm) | size (μm) |
| SG-treated | 98.10% | 3,140 | 3,203 | 1.13 | 14.3 |
| LAAC | | | | | |

LiSBs were assembled using the following sulphur impregnated LAAC based cathode materials:
Cell LC21-27-5: 0% Al+0% Cu+SG+63.12% S (Baseline)
Cell LC21-25-9: 0.15% Al+3.0% Cu+SG+71.0% S
Cell LC21-23-16: 0.3% Al+3.0% Cu+SG+67.30% S
Cell LC21-26-7: 0.45% Al+3.0% Cu+SG+65.97% S

These cells (CR 2032, 15 mm in diameter) had the following components:
Cathode: 60 (AC-S): 20 (graphite): 20 (PVDF) coated on aluminum foil
Electrolyte: 1 M of lithium bis(trifluoromethane sulfonyl)imide (LiN(SO2CF3)2) and 1% lithium nitrate in 1,2-dimethoxyethane (DME) and 1,3-dioxolane (DOXL).
Electrolyte amount used: 40-52 μL per 1 mg of active sulphur in the cathode
Separator: Celgard 25 micrometer film
Anode: 0.2 mm lithium metal
   Performance of LiSB with Sulphur Impregnated LAAC Cathode

Table 14 shows performance results of LiSBs with baseline LAAC and doped and SG treated LAAC which contained 63-71% sulphur content. All cells were cycled 500 times at 1 C/g using a 100% depth of discharge (1.7-3.0 V).

The 2^{nd} cycle capacity of LiSBs with the baseline cathode (LC21-27-5) was 590 mAh/g which dropped by approx. 5% of the 1^{st} cycled capacity (622 mAh/g). The capacity of the baseline LiSB continuously dropped to the 500^{th} cycle. The capacity retention of LC21-27-5 was 55.9% (based on the 1^{st} cycled capacity) after 500 cycles. Interestingly, the 2^{nd} cycled capacity of LiSBs with the 0.15% Al+3% Cu+SG cathode (LC 21-25-9) was 665 mAh/g which increased by 10% of the 1^{st} cycled capacity (594 mAh/g). The capacity retention (%) for LC 21-25-9 was calculated based on the 2^{nd} capacity. The 500 cycled capacity retention of LC21-25-9 was 74.4% which is significantly improved when compared with the baseline LiSB.

LiSBs with other metal doped and SG-treated cathodes (LC21-23-16 for 0.3% Al+3% Cu+SG and LC21-26-7 for 0.45% Al+3% Cu+SG) had initial capacities of 601 and 570 mAh/g, respectively. These two cells had poorer capacity retention (36.1% and 33.7%, respectively) than the baseline cells.

TABLE 14
LiS batteries with sulphur-impregnated LAAC tested 500 cycles at 1 C/g and
100% DoD.

| | | # of cycles | | | | | | | |
|---|---|---|---|---|---|---|---|---|---|
| Cell ID | Parameters | 1 | 2 | 50 | 100 | 200 | 300 | 400 | 500 |
| LC21-27-5 (baseline): | Capacity | 622 | 590 | 581 | 512 | 458 | 403 | 373 | 348 |
| 0% Al + 0% Cu + SG + 63.12% S | (mAh/g) | | | | | | | | |
| | Capacity | 100.0% | 94.9% | 93.3% | 82.3% | 73.6% | 64.7% | 60.0% | 55.9% |
| | retention | | | | | | | | |
| | (%) | | | | | | | | |
| LC21-25-9: | Capacity | 594 | 655 | 608 | 566 | 556 | 531 | 516 | 487 |
| 0.15% Al + 3.0% Cu + SG + | (mAh/g) | | | | | | | | |
| 71.0% S | Capacity | 90.6% | 100.0% | 92.8% | 86.4% | 84.9% | 81.0% | 78.7% | 74.4% |
| | retention | | | | | | | | |
| | (%) | | | | | | | | |
| LC21-23-16: | Capacity | 601 | 536 | 536 | 507 | 369 | 323 | 258 | 217 |
| 0.3% Al + 3.0% Cu + SG + | (mAh/g) | | | | | | | | |
| 67.30% S | Capacity | 100.0% | 89.2% | 89.2% | 84.4% | 61.4% | 53.8% | 42.9% | 36.1% |
| | retention | | | | | | | | |
| | (%) | | | | | | | | |
| LC21-26-7: | Capacity | 570 | 540 | 491 | 422 | 368 | 319 | 242 | 192 |
| 0.45% Al + 3.0% Cu + SG + | (mAh/g) | | | | | | | | |
| 65.97% S | Capacity | 100.0% | 94.8% | 86.2% | 74.1% | 64.5% | 56.0% | 42.6% | 33.7% |
| | retention | | | | | | | | |
| | (%) | | | | | | | | |

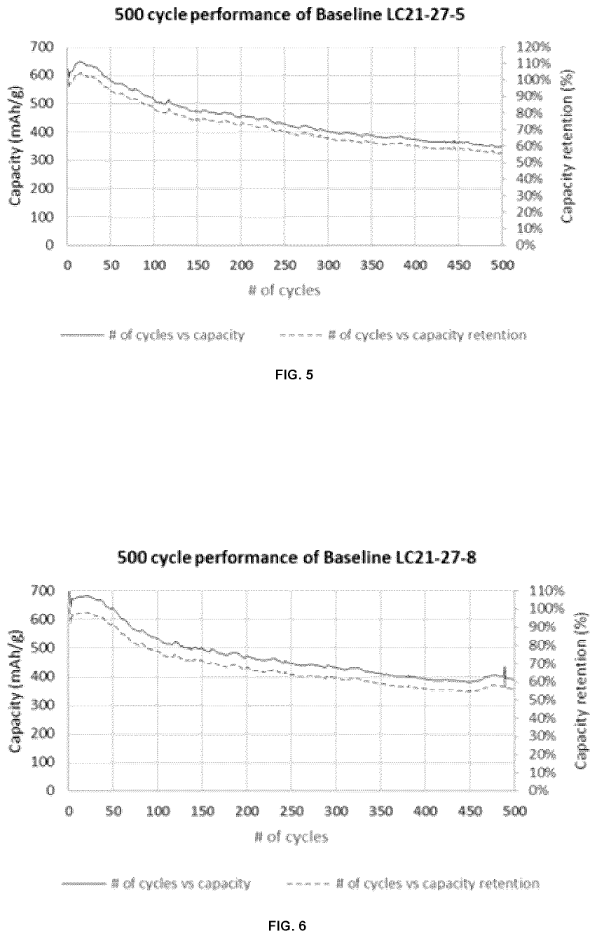

The two best LiSBs with baseline (LC21-27-8) and 0.15%+3% Cu+SG (LC21-25-10) were tested to confirm the effect of doping+SG treatment on the capacity retention improvement of LiSBs. The LiSB with the baseline cathode was tested to be a 1^{st} cycled capacity of 696 mAh/g and capacity retention of 55.7% (388 mAh/g) after 500 cycles, while the LiSB with 0.15%+3% Cu+SG cathode (LC21-25-10) achieved 1^{st} cycled and 2^{nd} cycled capacity of 462 and 578 mAh/g, respectively. The 500 cycled capacity retention of LC21-25-10 was 70.5% (407 mAh/g) based on the 2^{nd} capacity value. As observed in Table 14, the 2^{nd} cycled capacity of LC21-25-10 in Table 15 also increased from the initial capacity value. This increase of capacity after the 1^{st} capacity is shown in FIGS. 5-12 as further discussed below.

TABLE 15
LiS batteries LiSBs with baseline cathode in comparison with the best doped and
SG treated cathode tested 500 cycles at 1 C/g and 100% DoD.

| | | # of cycles | | | | | | | |
|---|---|---|---|---|---|---|---|---|---|
| Cell ID | Parameters | 1 | 2 | 50 | 100 | 200 | 300 | 400 | 500 |
| Baseline-LC21-27-8: | Capacity | 696 | 663 | 637 | 532 | 471 | 430 | 390 | 388 |
| | (mAh/g) | | | | | | | | |
| 0% Al + 0% Cu + SG + | Capacity | 100.0% | 95.3% | 91.5% | 76.5% | 67.7% | 61.8% | 56.1% | 55.7% |
| 63.12% S | retention | | | | | | | | |
| | (%) | | | | | | | | |
| LC21-25-10: | Capacity | 462 | 578 | 619 | 557 | 528 | 494 | 455 | 407 |
| 0.15% Al + 3.0% Cu + | (mAh/g) | | | | | | | | |
| SG + 71.0% S | Capacity | 80.0% | 100.0% | 107.2% | 96.4% | 91.3% | 85.5% | 78.7% | 70.5% |
| | retention | | | | | | | | |
| | (%) | | | | | | | | |

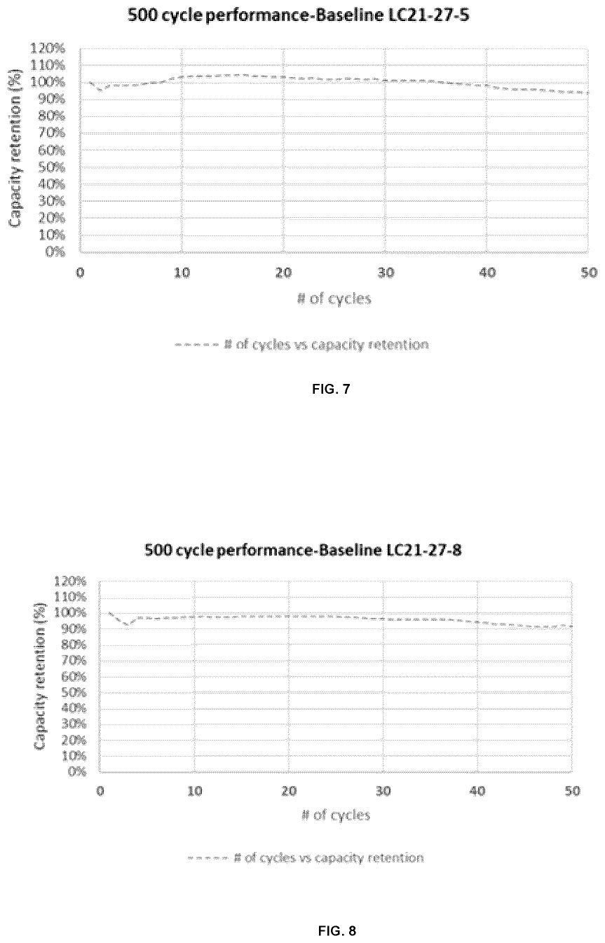

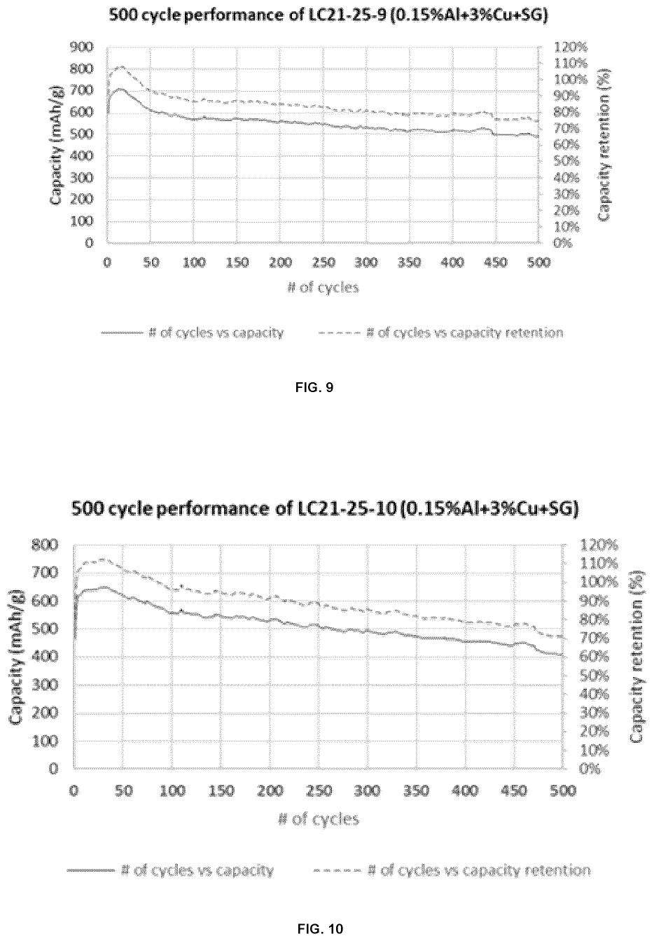

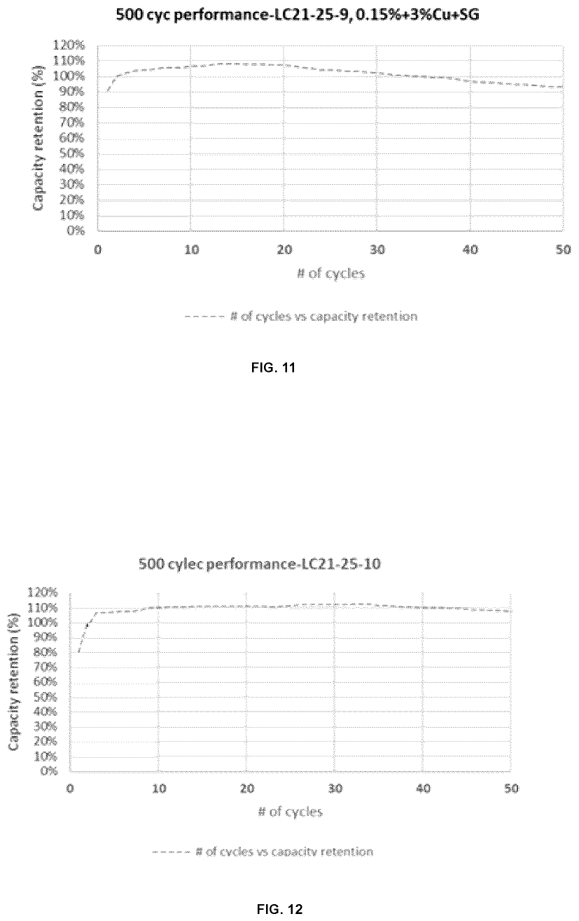

FIGS. 5-8 illustrate 500 cycle performance of LiS batteries with the baseline LAAC (LC21-27-5 and LC21-27-8) and FIGS. 9-12 illustrate 500 cycle performance of LiS batteries with 0.15% Al+3% Cu+SG LAAC (LC21-25-9 and LC21-25-10). FIGS. 7, 8, 11 and 12 each show an enlarged view of just the capacity retention for the first 50 cycles. i.e FIG. 7 shows show an enlarged view of just the capacity retention for the first 50 cycles of FIG. 5, FIG. 8 shows show an enlarged view of just the capacity retention for the first 50 cycles of FIG. 6, FIG. 11 shows show an enlarged view of just the capacity retention for the first 50 cycles of FIG. 9, and FIG. 12 shows show an enlarged view of just the capacity retention for the first 50 cycles of FIG. 10. FIGS. 5-8 show that the capacity and capacity retention of LiS batteries with the baseline (SG-treated LAAC, not metal doped) slightly increased in the first 50 cycles (maximum 4.3% increase for LC21-27-5 and gradually decrease for LC21-27-8) and constantly declined between 100th and 500^{th} cycle. FIGS. 7-8 show the capacity retention of the baseline LiSBs in the first 50 cycles.

FIGS. 9-12 show that the capacity and capacity retention of LiS batteries with 0.15% Al+3% Cu+SG (LC21-25-9 and LC21-25-10) significantly increased in 50 cycles (maximum 8.2% increase based on the 2^{nd} cycled capacity for LC21-25-9 and maximum 10.8% increase based on the 2^{nd} cycled capacity for LC21-25-10) and then gradually declined between 100th and 500th cycle. FIGS. 11-12 show the capacity retention of LiS batteries with 0.15% Al and 3% Cu+SG in the first 50 cycles.

The results of testing LiS batteries fabricated with a 0.15% Al+3% Cu+SG cathode suggest that lithium polysulfides (polar) that are created (reduced) from the active sulphur in the cathode during the discharge mode of the LiSB effectively interacted in the doped and SG-treated LAAC and better trapped in the cathode than the baseline LiS battery (SG-treated LAAC cathode).

To summarize, the comparative results of LiS batteries with baseline and metal-doped and SG-LAAC shows that the capacity and capacity retention values of LiSBs were significantly improved when the LAAC was doped at 0.15% Al and 3% Cu and treated with sweeping gas.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### REFERENCES

The following references are of interest with respect to the subject matter described herein. Each of the following references is incorporated by reference herein in its entirety.
Quach, Nguyen Khanh Nguyen et al. (2017) The Influence of the Activation Temperature on the Structural Properties of the Activated Carbon Xerogels and Their Electrochemical Performance, Advances in Materials Science and Engineering, 2017, 8308612, doi.org/10.1155/2017/8308612.

1. A composition comprising activated carbon, an electro-stabilizing agent, and a wettability enhancing agent, wherein the electro-stabilizing agent comprises copper and the wettability enhancing agent comprises aluminum, and wherein the activated carbon comprises an oxygen-stripped activated carbon.

2. A method of producing activated carbon, comprising:
combining activated carbon with an electro-stabilizing agent and a wettability enhancing agent to form an activated carbon mixture; and
exposing the activated carbon mixture to a sweeping gas at an elevated temperature, wherein the sweeping gas comprises a combination of an inert gas and a reducing gas.

3. A method of producing activated carbon, comprising:
combining activated carbon with an electro-stabilizing agent and/or a wettability enhancing agent to form an activated carbon mixture; and
exposing the activated carbon mixture to a sweeping gas at an elevated temperature, wherein the sweeping gas comprises a combination of an inert gas and a reducing gas;
wherein the electro-stabilizing agent comprises Sc, Ti, V, Cr, Mn, Ni, Cu, Zn, Y, Zr, Nb, Mo, Tc, Ru, Rh, Pb, Ag, La, Hf, Ta, W, Re, Os, Ir, Pt, Au, or Ac.

4. The method of claim 2, wherein the inert gas comprises nitrogen, argon or helium; and wherein the reducing gas comprises hydrogen, ammonia, carbon monoxide, forming gas or syngas.

5. The method of claim 2, wherein the sweeping gas comprises between about 80% and about 98% of the inert gas and about 2% to about 20% of the reducing gas.

6. The method of claim 2, wherein the elevated temperature is between about 750° C. and about 950° C.

7. The method of claim 2, wherein during the step of exposing the activated carbon to the sweeping gas, the sweeping gas is supplied at a flow rate of between 0.25 to 1.0 L/minute, the sweeping gas is sprayed over or through the activated carbon, optionally wherein the sweeping gas is sprayed over or through the activated carbon with a superficial velocity relative to a surface of the activated carbon of between 0.25 cm/min to 7.0 cm/min, optionally wherein the step of exposing the activated carbon to the sweeping gas is conducted at atmospheric pressure, and further optionally wherein the step of exposing the activated carbon to the sweeping gas is conducted for a period of between 0.5 hours and 9 hours.

8. (canceled)

9. (canceled)

10. (canceled)

11. (canceled)

12. The method of claim 2, comprising drying the activated carbon mixture prior to the step of exposing the activated carbon mixture to the sweeping gas or comprising micronizing the activated carbon prior to the step of exposing the activated carbon mixture to the sweeping gas.

13. (canceled)

14. A composition made by the method of claim 2.

15. The method of claim 2, wherein the electro-stabilizing agent comprises a conductive metal, wherein the electro-stabilizing agent comprises a transition metal, or wherein the electro-stabilizing agent comprises Sc, Ti, V, Cr, Mn, Co, Ni, Cu, Zn, Y, Zr, Nb, Mo, Tc, Ru, Rh, Pb, Ag, La, Hf, Ta, W, Re, Os, Ir, Pt, Au, or Ac.

16. (canceled)

17. (canceled)

18. The method of claim 2, wherein the electro-stabilizing agent comprises copper or wherein the wettability enhancing agent comprises aluminum.

19. (canceled)

20. The method of claim 2, wherein the electro-stabilizing agent comprises copper and wherein the wettability enhancing agent comprises aluminum.

21. The composition or method of any one of claims 1 to 20, wherein:
the wettability enhancing agent comprises alumina or activated alumina (γ-Al₂O₃);
the wettability enhancing agent comprises a compound that provides enhanced interactions between polar and non-polar substances; or
the electro-stabilizing agent and the wettability enhancing agent are non-combustible.

22. (canceled)

23. The method of claim 2, wherein:
the electro-stabilizing agent is present in the composition in an amount of about 0.5% to about 4.0% by weight based on the elemental content of the electro-stabilizing agent, optionally about 1% to about 3.5% by weight based on the elemental content of the electro-stabilizing agent;
the wettability enhancing agent is present in the composition in an amount of about 0.15% to about 1.5% by weight based on the elemental content of the wettability enhancing agent, optionally about 0.45% to about 1.0% by weight based on the elemental content of the wettability enhancing agent;
the activated carbon is produced from lignin, wherein the electro-stabilizing agent is present in an amount of between about 2.75% and 3.25% by weight, and wherein the wettability enhancing agent is present in an amount of between about 0.50% and 1.25% by weight; or
the activated carbon is produced from coconut husk, wherein the electro-stabilizing agent is present in an amount of between about 2.75% and 3.25% by weight, and wherein the wettability enhancing agent is present in an amount of between about 0.25% and 1.0% by weight.

24. (canceled)

25. (canceled)

26. (canceled)

27. (canceled)

28. The composition produced by the method of claim 2, wherein:
the activated carbon is produced from lignin or a high lignin feedstock and has a BET surface area of at least 2500 m²/g;
the activated carbon has a pore volume of at least 1 cc/g which is predominantly micro-pores;
the activated carbon is produced from lignin or a high lignin feedstock and has a mean particle size of less than about 15 μm without micronization, or less than about 7 μm with micronization; and/or
the activated carbon has a bulk density of at least about 0.25 g/cc.

29. An activated carbon made by the method of claim 2.

30. An electrode comprising a composition made by the method of claim 2.

31. A supercapacitor or battery comprising an electrode as defined in claim 30, optionally wherein:
the battery is a lithium-sulphur battery and the electrode comprises activated carbon comprising the electro-stabilizing agent at a concentration in the range of about 0.5% to about 3.5% by weight, and/or wherein the electrode comprises activated carbon comprising the wettability enhancing agent at a concentration in the range of about 0.1% to about 0.2% by weight; or
the supercapacitor comprises an electrode that comprises activated carbon comprising the electro-stabilizing agent at a concentration in the range of about 1% to about 3.5% by weight, and/or wherein the electrode comprises activated carbon comprising the wettability enhancing agent at a concentration in the range of about 0.45% to about 1.0% by weight.

32. (canceled)

33. (canceled)

34. A building or modular building component containing an energy storage system comprising a supercapacitor or battery comprising an electrode as defined in claim 30.

35. A building or modular building component containing an energy storage system comprising an activated carbon as defined in claim 29.

36. (canceled)

37. (canceled)

38. (canceled)

39. (canceled)

40. (canceled)

41. (canceled)

42. (canceled)

43. (canceled)

44. (canceled)
